(19) United States
(12) Patent Application Publication
(10) Pub. No.: US 2008/0114638 A1
(43) Pub. Date: May 15, 2008

(54) PARAMETER-BASED APPOINTMENT SCHEDULING SYSTEM AND METHOD

(75) Inventors: Russ COLLIAU, Roseville, CA (US); Roy HIGGS, Roseville, CA (US)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(73) Assignee: INSPECTION MANAGEMENT SYSTEMS, INC., Roseville, CA (US)

(21) Appl. No.: 11/558,875

(22) Filed: Nov. 10, 2006

(51) Int. Cl. G06Q 10/00

(52) U.S. Cl. 705/9; 705/8

(57) ABSTRACT

A system for automatically scheduling an appointment for performing a task includes a task time generation module configured to calculate a total time for performing the task in accordance with task parameters provided by a user. The system includes an availability determination module in communication with the task time generation module. The availability determination module is configured to generate a list of entities available for performing the task in accordance with the total time for performing the task, schedules of each entity, and a date/time window specified by the user. The system includes an appointment module in communication with the availability determination module. The appointment module is configured to schedule the appointment for performing the task within the date/time window in accordance with a user selection of at least one entity from the list of available entities.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever.

### BACKGROUND

1. Field of the Invention

The present invention relates to appointment and scheduling systems. More particularly, the present invention relates to a parameter-based appointment scheduling system and method.

2. Background Information

Efficiently and optimally scheduling appointments for third parties to perform various tasks for users can pose certain difficulties. In particular, if the task to be performed is large, it may be difficult to accurately estimate the overall time needed to perform the task. Consequently, appointments can be scheduled that do not give the third party adequate time to complete the task. In addition, the third party may have to attend appointments over a geographically diverse area, and the time needed to travel to, from, and between these appointments may not be accurately reflected in the schedule of appointments to give the third party adequate time to reach each appointment.

### SUMMARY OF THE INVENTION

A parameter-based appointment scheduling system and method are disclosed. In accordance with exemplary embodiments of the present invention, according to a first aspect of the present invention, a system for automatically scheduling an appointment for performing the task includes a task time generation module. The task time generation module is configured to calculate a total time for performing the task in accordance with task parameters provided by a user. The system includes an availability determination module in communication with the task time generation module. The availability determination module is configured to generate a list of entities available for performing the task in accordance with the total time for performing the task, schedules of each entity, and a date/time window specified by the user. The system includes an appointment module in communication with the availability determination module. The appointment module is configured to schedule the appointment for performing the task within the date/time window in accordance with a user selection of at least one entity from the list of available entities.

According to the first aspect, the system can include a fee determination module. The fee determination module can be configured to determine a total fee for the appointment in accordance with the task parameters provided by the user. The availability determination module can include a geographical proximity scheduling module. The geographical proximity scheduling module can be configured to sort the list of available entities in geographic order in accordance with travel times to and from the task site. The system can include an artifact delivery module in communication with the appointment module. The artifact delivery module can be configured to communicate artifacts resulting from an entity performing the task. The system can include a workflow management module in communication with the appointment module. The workflow management module can be configured to manage task workflows for an appointment. The system can include a display module in communication with the appointment module. The display module can be configured to display a schedule of available appointments. The system can include a storage module in communication with the appointment module. The storage module can be configured to store at least the schedule of appointments.

According to the first aspect, the system can include a communication module in communication with the appointment module. For example, the appointment module can be configured to communicate an appointment confirmation to appointment participants via the communication module. The appointment module can be configured to communicate an appointment reminder to each entity for each appointment via the communication module. The appointment reminder can include a log of substantially all appointments for a day for the entity. The appointment reminder can include travel directions for appointments. The appointment reminder can include a message customized for the entity. The availability determination module can be configured to determine travel time to and from a task site in accordance with an address of the task site. The availability determination module can be configured to include the travel time in generating the list of available entities. The availability determination module can be configured to receive a travel offset for modifying the travel time to and from the task site. The availability determination module can be configured to modify a time length of the travel time in accordance with the travel offset.

According to the first aspect, the availability determination module can be configured to generate a list of appointments ranked in order of geographic proximity to a predetermined location. The availability determination module can be configured to optimize a travel schedule for each entity in accordance with geographical locations of appointments for each day. The availability determination module can be configured to assign a plurality of entities for the appointment. The availability determination module can be configured to allot a portion of the appointment to each of the plurality of entities. The task can comprise, for example, an inspection of a property. The task parameters can comprise, for example, specifications of the property. The specifications of the property can include, for example, a total square footage of the property. Each entity can comprise an individual, a company, or the like.

According to a second aspect of the present invention, a method of automatically scheduling an appointment for performing a task includes the steps of: a.) calculating a total time for performing the task in accordance with task parameters provided by a user; b.) generating a list of entities available for performing the task in accordance with the total time for performing the task, schedules of each entity, and a date/time window specified by the user; and c.) scheduling the appointment for performing the task within the date/time window in accordance with a user selection of at least one entity from the list of available entities.

According to the second aspect, the method can include the steps of: d.) determining a total fee for the appointment in accordance with the task parameters provided by the user; e.) sorting the list of available entities in geographic order in accordance with travel times to and from a task site; f.) communicating artifacts resulting from an entity performing the task; g.) displaying a schedule of available appointments; h.) storing at least the schedule of appointments; i.) communicating an appointment confirmation to appointment participants; and j.) communicating an appointment reminder to each entity for each appointment. The appointment reminder can include a log of substantially all appointments for a day for the entity. The appointment reminder can include travel directions for appointments. The appointment reminder can include a message customized for the entity.

According to the second aspect, the method can include the steps of: k.) determining travel time to and from a task site in accordance with an address of the task site; l.) scheduling the appointment to include the travel time; m.) receiving a travel offset for modifying the travel time to and from the task site; n.) modifying a time length of the travel time in accordance with the travel offset; o.) generating a list of appointments ranked in order of geographic proximity to a predetermined location; p.) optimizing a travel schedule for each entity in accordance with geographical locations of appointments for each day; q.) assigning a plurality of entities for the appointment; and r.) allotting a portion of the appointment to each of the plurality of entities. The task can comprise, for example, an inspection of a property. The task parameters can comprise, for example, specifications of the property. The specifications of the property can include, for example, a total square footage of the property. Each entity can comprise an individual, a company, or the like.

According to a third aspect of the present invention, a system for automatically scheduling an appointment for inspecting a property includes an inspection duration determination module. The inspection duration determination module is configured to determine a total inspection time for inspecting the property in accordance with specifications of the property provided by a user. The system includes a roster generation module in communication with the inspection duration determination module. The roster generation module is configured to generate a list of inspectors available to inspect the property in accordance with the total inspection time, schedules of the inspectors, and an inspection schedule window specified by the user. The roster generation module is configured to receive an inspector selection indication from the user for selecting at least one of the available inspectors. The system includes a scheduler module in communication with the roster generation module. The scheduler module is configured to schedule an inspection appointment within the inspection schedule window in accordance with the inspector selection indication.

According to the third aspect, the inspection duration determination module can be configured to determine a total fee for the inspection appointment in accordance with the specifications of the property provided by the user. The system can include a geographical proximity scheduling module in communication with the roster generation module. The geographical proximity scheduling module can be configured to sort the list of available inspectors in geographic order in accordance with travel times to and from the property. The system can include an artifact delivery module in communication with the scheduler module. The artifact delivery module can be configured to communicate artifacts resulting from an inspector performing an inspection. The system can include a workflow management module in communication with the scheduler module. The workflow management module can be configured to manage task workflows for an inspection appointment. The system can include a display module in communication with the scheduler module. The display module can be configured to display a schedule of available inspection appointments. The system can include a storage module in communication with the scheduler module. The storage module can be configured to store at least the schedule of inspection appointments.

According to the third aspect, the system can include a communication module in communication with the scheduler module. The scheduler module can be configured to communicate an inspection appointment confirmation to inspection appointment participants via the communication module. The scheduler module can be configured to communicate an inspection appointment reminder to each inspector for each inspection appointment via the communication module. The inspection appointment reminder can include a log of substantially all inspection appointments for a day for the inspector. The inspection appointment reminder can include travel directions for inspection appointments. The inspection appointment reminder can include a message customized for the inspector.

According to the third aspect, the roster generation module can be configured to determine travel time to and from the property in accordance with an address of the property. The roster generation module can be configured to include the travel time in scheduling the inspection appointment. The roster generation module can be configured to receive a travel offset for modifying the travel time to and from the property. The roster generation module can be configured to modify a time length of the travel time in accordance with the travel offset. The roster generation module can be configured to generate a list of inspection appointments ranked in order of geographical proximity to a predetermined location. The roster generation module can be configured to optimize a travel schedule for each inspector in accordance with geographical locations of inspection appointments for each day. The roster generation module can be configured to assign a plurality of inspectors for the inspection appointment. The roster generation module can be configured to allot a portion of the inspection appointment to each of the plurality of inspectors. The specifications of the property can include, for example, a total square footage of the property.

According to a fourth aspect of the present invention, a system for automatically scheduling appointments for inspecting a property includes a time determination engine. The time determination engine is configured to determine an inspection time for inspecting the property in accordance with specifications of the property. The system includes a calendar engine in communication with the time determination engine. The calendar engine is configured to generate a list of inspectors available to inspect the property in accordance with the inspection time, schedules of inspectors, and an inspection schedule date window specified by the user. The calendar engine is configured to receive an inspector selection indication from the user for choosing at least one of the available inspectors. The system includes a scheduler engine in communication with the calendar engine. The scheduler engine is configured to schedule the appointment during the inspection schedule date window in accordance with the inspector selection indication.

According to the fourth aspect, the system can include a fee calculation engine. The fee calculation engine can be configured to determine a total fee for the appointment in accordance with the specifications of the property. The calendar engine can comprise a geographical proximity scheduling engine. The geographical proximity scheduling engine can be configured to sort the list of available inspectors in geographic order in accordance with travel times to and from the property. The system can include an artifact delivery engine in communication with the scheduler engine. The artifact delivery engine can be configured to communicate artifacts resulting from an inspector performing an inspection. The system can include a workflow management engine in communication with the scheduler engine. The workflow management engine can be configured to manage task workflows for an appointment. The system can include a graphical user interface module in communication with the scheduler engine. The system can include a database module in communication with the scheduler engine. The system can include a transceiver module in communication with the scheduler engine.

According to a fifth aspect of the present invention, a method of automatically scheduling an appointment for inspecting a property includes the steps of: a.) determining a total inspection time for inspecting the property in accordance with specifications of the property provided by a user; b.) generating a list of inspectors available to inspect the property in accordance with the total inspection time, schedules of the inspectors, and an inspection schedule window specified by the user; c.) receiving an inspector selection indication from the user for selecting at least one of the available inspectors; and d.) scheduling an inspection appointment within the inspection schedule window in accordance with the inspector selection indication.

According to the fifth aspect, the method can include the steps of: e.) determining a total fee for the inspection appointment in accordance with the specifications of the property provided by the user; f.) sorting the list of available inspectors in geographic order in accordance with travel times to and from the property; g.) communicating artifacts resulting from an inspector performing an inspection; h.) displaying a schedule of available inspection appointments; i.) storing at least the schedule of inspection appointments; j.) communicating an inspection appointment confirmation to inspection appointment participants; and k.) communicating an inspection appointment reminder to each inspector for each inspection appointment. The inspection appointment reminder can include a log of substantially all inspection appointments for a day for the inspector. The inspection appointment reminder can include travel directions for inspection appointments. The inspection appointment reminder can also include a message customized for each inspector.

According to the fifth aspect, the method can include the steps of: l.) determining travel time to and from the property in accordance with an address of the property; m.) scheduling the inspection appointment to include the travel time; n.) receiving a travel offset for modifying the travel time to and from the property; o.) modifying a time length of the travel time in accordance with the travel offset; p.) generating a list of inspection appointments ranked in order of geographical proximity to a predetermined location; q.) optimizing a travel schedule for each inspector in accordance with geographical locations of inspection appointments for each day; r.) assigning a plurality of inspectors for the inspection appointment; and s.) allotting a portion of the inspection appointment to each of the plurality of inspectors. The specifications of the property can include, for example, a total square footage of the property.

According to a sixth aspect of the present invention, a system for automatically scheduling an appointment for inspecting a property includes means for determining inspection time. The inspection time determining means is configured to determine a total inspection time for inspecting the property in accordance with specifications of the property provided by a user. The system includes means for generating a roster in communication with the inspection time determining means. The roster generating means is configured to generate a list of inspectors available to inspect the property in accordance with the total inspection time, schedules of the inspectors, and an inspection schedule window specified by the user. The roster generating means is configured to receive an inspector selection indication from the user for selecting at least one of the available inspectors. The system includes means for scheduling in communication with the roster generating means. The scheduling means is configured to schedule an inspection appointment within the inspection schedule window in accordance with the inspector selection indication.

According to the sixth aspect, the inspection time determining means can be configured to determine a total fee for the inspection appointment in accordance with the specifications of the property provided by the user. The roster generating means can include means for sorting geographically. The geographical sorting means can be configured to sort the list of available inspectors in geographic order in accordance with travel times to and from the property. The system can include means for delivering artifacts in communication with the scheduling means. The artifact delivering means can be configured to communicate artifacts resulting from an inspector performing an inspection. The system can include means for managing workflow in communication with the scheduling means. The workflow managing means can be configured to manage task workflows for an inspection appointment. The system can include means for displaying in communication with the scheduling means. The displaying means can be configured to display a schedule of available inspection appointments. The system can include means for storing in communication with the scheduling means. The storing means can be configured to store at least the schedule of inspection appointments.

According to the sixth aspect, the system can include means for communicating in communication with the scheduling means. For example, the scheduling means can be configured to communicate an inspection appointment confirmation to inspection appointment participants via the communicating means. The scheduling means can be configured to communicate an inspection appointment reminder to each inspector for each inspection appointment via the communicating means. The inspection appointment reminder can include a log of substantially all inspection appointments for a day for the entity. The inspection appointment reminder can include travel directions for inspection appointments. The inspection appointment reminder can also include a message customized for the inspector.

According to the sixth aspect, the roster generating means can be configured to determine travel time to and from the property in accordance with an address of the property. The roster generating means can be configured to include the travel time in scheduling the inspection appointment. The roster generating means can be configured to receive a travel offset for modifying the travel time to and from the property. The roster generating means can be configured to modify a time length of the travel time in accordance with the travel offset. The roster generating means can be configured to generate a list of inspection appointments ranked in order of geographical proximity to a predetermined location. The roster generating means can be configured to optimize a travel schedule for each inspector in accordance with geographical locations of inspection appointments for each day. The roster generating means can be configured to assign a plurality of inspectors for the inspection appointment. The roster generating means can be configured to allot a portion of the inspection appointment to each of the plurality of inspectors. The specifications of the property can include, for example, a total square footage of the property.

According to a seventh aspect of the present invention, a system for automatically scheduling an appointment for performing a task includes means for generating a task time. The task time generating means is configured to calculate a total time for performing the task in accordance with task parameters provided by a user. The system includes means for determining availability in communication with the task time generating means. The availability determining means is configured to generate a list of entities available for performing the task in accordance with the total time for performing the task, schedules of each entity, and a date/time window specified by the user. The system includes means for scheduling an appointment in communication with the availability determining means. The appointment scheduling means is configured to schedule the appointment for performing the task within the date/time window in accordance with a user selection of at least one entity from the list of available entities.

According to the seventh aspect, the system can include means for determining a fee. The fee determining means can be configured to determine a total fee for the appointment in accordance with the task parameters provided by the user. The availability determining means can include means for geographical proximity scheduling. The geographical proximity scheduling means can be configured to sort the list of available entities in geographic order in accordance with travel times to and from the task site. The system can include means for delivering artifacts in communication with the appointment scheduling means. The artifact delivering means can be configured to communicate artifacts resulting from an entity performing the task. The system can include means for managing workflow in communication with the appointment scheduling means. The workflow managing means can be configured to manage task workflows for an appointment. The system can include means for displaying in communication with the appointment scheduling means. The displaying means can be configured to display a schedule of available appointments. The system can include means for storing information in communication with the appointment scheduling means. The information storing means can be configured to store at least the schedule of appointments.

According to the seventh aspect, the system can include means for communicating in communication with the appointment scheduling means. The appointment scheduling means can be configured to communicate an appointment confirmation to appointment participants via the communicating means. The appointment scheduling means can be configured to communicate an appointment reminder to each entity for each appointment via the communicating means. The appointment reminder can include a log of substantially all appointments for a day for the entity. The appointment reminder can include travel directions for appointments. The appointment reminder can also include a message customized for the entity.

According to the seventh aspect, the availability determining means can be configured to determine travel time to and from a task site in accordance with an address of the task site. The availability determining means can be configured to include the travel time in scheduling the appointment. The availability determining means can be configured to receive a travel offset for modifying the travel time to and from the task site. The availability determining means can be configured to modify a time length of the travel time in accordance with the travel offset. The availability determining means can be configured to generate a list of appointments ranked in order of geographic proximity to a predetermined location. The availability determining means can be configured to optimize a travel schedule for each entity in accordance with geographical locations of appointments for each day. The availability determining means can be configured to assign a plurality of entities for the appointment. The availability determining means can be configured to allot a portion of the appointment to each of the plurality of entities. The task can comprise, for example, an inspection of a property. The task parameters can comprise, for example, specifications of the property. The specifications of the property can include, for example, a total square footage of the property. Each entity can comprise an individual, a company, or the like.

According to an eighth aspect of the present invention, a computer-readable medium contains a computer program for automatically scheduling an appointment for inspecting a property. The computer program performs the steps of: a.) determining a total inspection time for inspecting the property in accordance with specifications of the property provided by a user; b.) generating a list of inspectors available to inspect the property in accordance with the total inspection time, schedules of the inspectors, and an inspection schedule window specified by the user; c.) receiving an inspector selection indication from the user for selecting at least one of the available inspectors; and d.) scheduling an inspection appointment within the inspection schedule window in accordance with the inspector selection indication.

According to the eighth aspect, the computer program can perform the step of: e.) determining a total fee for the inspection appointment in accordance with the specifications of the property provided by the user; f.) sorting the list of available inspectors in geographic order in accordance with travel times to and from the property; g.) generating a signal configured to cause a schedule of available inspection appointments to be displayed; h.) generating a signal configured to cause at least the schedule of inspection appointments to be stored; i.) generating a signal configured to cause an inspection appointment confirmation to be communicated to inspection appointment participants; and j.) generating a signal configured to cause an inspection appointment reminder to be communicated to each inspector for each inspection appointment. The inspection appointment reminder can include a log of substantially all inspection appointments for a day for the inspector. The inspection appointment reminder can include travel directions for inspection appointments. The inspection appointment reminder can also include a message customized for the inspector.

According to the eighth aspect, the computer program can perform the steps of: k.) determining travel time to and from the property in accordance with an address of the property; l.) scheduling the inspection appointment to include the travel time; m.) receiving a travel offset for modifying the travel time to and from the property; n.) modifying a time length of the travel time in accordance with the travel offset; o.) generating a list of inspection appointments ranked in order of geographical proximity to a predetermined location; p.) optimizing a travel schedule for each inspector in accordance with geographical locations of inspection appointments for each day; q.) assigning a plurality of inspectors for the inspection appointment; and r.) allotting a portion of the inspection appointment to each of the plurality of inspectors. The specifications of the property can include, for example, a total square footage of the property.

According to a ninth aspect of the present invention, a computer-readable medium contains a computer program for automatically scheduling an appointment for performing a task. The computer program performs the steps of: a.) calculating a total time for performing the task in accordance with task parameters provided by a user; b.) generating a list of entities available for performing the task in accordance with the total time for performing the task, schedules of each entity, and a date/time window specified by the user; and c.) scheduling the appointment for performing the task within the date/time window in accordance with a user selection of at least one entity from the list of available entities.

According to the ninth aspect, the computer program can perform the step of: d.) determining a total fee for the appointment in accordance with task parameters provided by the user; e.) sorting the list of available entities in geographic order in accordance with travel times to and from a task site; f.) generating a signal configured to cause a schedule of available appointments to be displayed; g.) generating a signal configured to cause at least the schedule of appointments to be stored; h.) generating a signal configured to cause an appointment confirmation to be communicated to appointment participants; and i.) generating a signal configured to cause an appointment reminder to be communicated to each entity for each appointment. The appointment reminder can include a log of substantially all appointments for a day for the entity. The appointment reminder can include travel directions for appointments. The appointment reminder can include a message customized for the entity.

According to the ninth aspect, the computer program can perform the steps of: j.) determining travel time to and from a task site in accordance with an address of the task site; k.) scheduling the appointment to include the travel time; l.) receiving a travel offset for modifying the travel time to and from the task site; m.) modifying a time length of the travel time in accordance with the travel offset; n.) generating a list of appointments ranked in order of geographic proximity to a predetermined location; o.) optimizing a travel schedule for each entity in accordance with geographical locations of appointments for each day; p.) assigning a plurality of entities for the appointment; and q.) allotting a portion of the appointment to each of the plurality of entities. The task can comprise, for example, an inspection of a property. The task parameters can comprise, for example, specifications of the property. The specifications of the property can include, for example, a total square footage of the property. Each entity can comprise, for example, an individual, a company, or the like.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a block diagram illustrating a system for automatically scheduling an appointment for performing a task, in accordance with an exemplary embodiment of the present invention.

FIG. 2 is a block diagram illustrating a system for automatically scheduling appointments for inspecting a property, in accordance with an exemplary embodiment of the present invention.

FIGS. 3A and 3B are diagrams illustrating a first graphical user interface that can be displayed via the display module for automatically scheduling appointments for inspecting a property, in accordance with an exemplary embodiment of the present invention.

FIG. 4 is a diagram illustrating a second graphical user interface that can be displayed via the display module for automatically scheduling appointments for inspecting a property, in accordance with an exemplary embodiment of the present invention.

FIGS. 5A and 5B are diagrams illustrating a third graphical user interface that can be displayed via the display module for automatically scheduling appointments for inspecting a property, in accordance with an exemplary embodiment of the present invention.

FIGS. 6A and 6B are diagrams illustrating a fourth graphical user interface that can be displayed via the display module for automatically scheduling appointments for inspecting a property, in accordance with an exemplary embodiment of the present invention.

FIG. 7 is a diagram illustrating a fifth graphical user interface that can be displayed via the display module for automatically scheduling appointments for inspecting a property, in accordance with an exemplary embodiment of the present invention.

FIG. 8 is a flowchart illustrating steps for automatically scheduling an appointment for inspecting a property, in accordance with an exemplary embodiment of the present invention.

FIG. 9 is a flowchart illustrating steps for automatically scheduling an appointment for performing a task, in accordance with an exemplary embodiment of the present invention.

FIG. 10 is a flowchart illustrating steps for automatically scheduling an appointment for performing a task, in accordance with an alternative exemplary embodiment of the present invention.

### DETAILED DESCRIPTION OF THE PREFERRED EMBODIMENTS

Exemplary embodiments of the present invention are directed to a parameter-based appointment scheduling system and method. In particular, the present invention can automatically schedule appointments for performing any suitable type of task. According to exemplary embodiments, the user can provide various parameters for performing the task. Based on such parameters, the present invention can automatically calculate the total time needed to perform the task by an entity, such as, for example, a service professional or the like, as well as any concomitant fees for performing the task. Additionally, exemplary embodiments can geographically sort the order of appointments to display to a user when scheduling an appointment. Travel times for the entity can be calculated between the appointment being scheduled and other locations on the service professional's calendar. Using RIGHT NOW SCHEDULING™, an entity for a task can be scheduled on demand to swiftly satisfy a user's request. For example, locations of each entity can be tracked via GPS or other suitable technology. When the present invention receives a request for an appointment that needs to be scheduled for immediate service, exemplary embodiments can identify the entity that is closest to the given location and can perform the requested task, and then schedule that entity to perform the task. Furthermore, exemplary embodiments of the present invention can combine appointments for a user from multiple, disparate, disconnected entities to allow a user to schedule multiple types of tasks or services from multiple entities so that all of the tasks can be performed for the user at the same time. Such multi-entity scheduling can eliminate the need for the user to oversee various entities at different times.

For purposes of illustration and not limitation, the task can be, for example, the inspection of a home or other building or structure. The user can provide suitable specifications of their home, such as the total square footage, to the system. The present invention can be configured to calculate the total time to inspect the home based on the total square footage and/or other suitable parameters. In addition, exemplary embodiments can calculate an estimate of the total fees for performing the inspection.

According to exemplary embodiments, the user can also specify one or more date/time windows during which they would like to have the task performed. Using the date/time window(s) specified by the user, the total time calculated for performing the task, including travel times to and from the task site, and the schedules of all entities or individuals that could perform the task, the present invention is configured to generate a list of entities or individuals available for performing the task. Continuing with the present illustration, the system can generate a list of, for example, inspectors available to inspect the home in accordance with the total inspection time, the schedules of the inspectors, and the inspection schedule window(s) specified by the user. From the generated list (which can be sorted geographically, as described above), the user can select or otherwise choose one or more of the available entities or individuals, such as, for example, the inspector(s) available to inspect the home. The present invention can then automatically schedule an appointment for performing the task within the date/time window(s) specified by the user in accordance with the one or more entities or individuals selected by the user. Thus, exemplary embodiments of the present invention can automatically schedule appointments for the user based on appropriate parameters provided by the user.

According to additional exemplary embodiments, the present invention can determine the travel time to and from the task site based on, for example, the address of the task site (e.g., the address of the home to be inspected). In scheduling the appointment, the travel time to and from the task site can be factored into the appointment schedule to ensure that the total appointment time (travel and task performance) meets the date/time window(s) specified by the user.

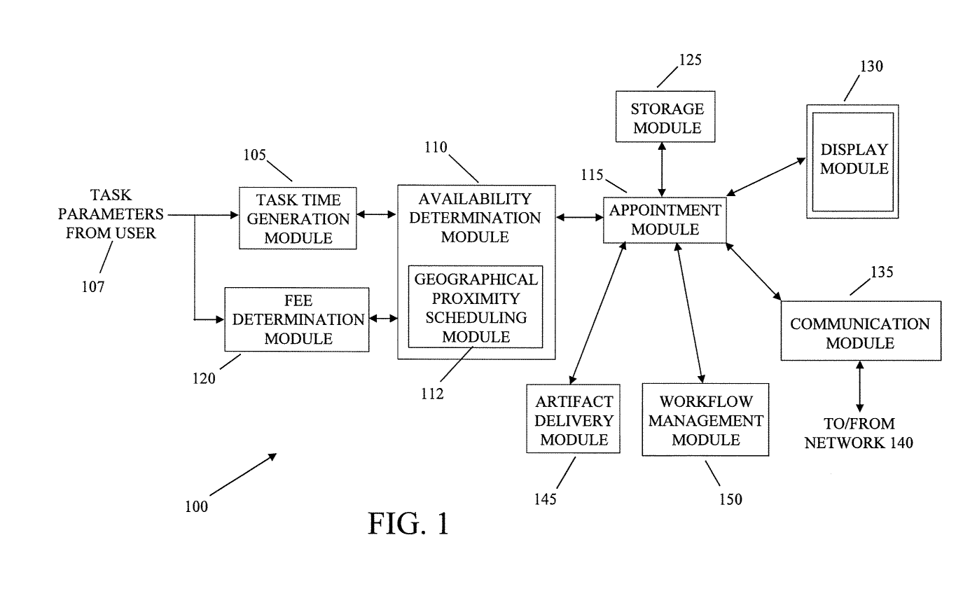

These and other aspects and embodiments of the present invention will now be described in greater detail. FIG. 1 is a block diagram illustrating a system 100 for automatically scheduling an appointment for performing a task, in accordance with an exemplary embodiment of the present invention. According to exemplary embodiments, the task to be performed can be any suitable type of task, service, job, assignment, chore, duty, endeavor, enterprise, project, undertaking, function, mission, errand or other work for which one or more entities or individuals (including the users themselves) can be scheduled. 100501 The system 100 includes a task time generation module 105. The task time generation module 105 is configured to calculate the total (or substantially total) time for performing the task in accordance with or otherwise based on one or more suitable task parameters 107 provided by a user. Any appropriate type and number of task parameters 107 can be provided by the user, and the nature, extent and type of those task parameters 107 will depend on the type of task to be performed. For purposes of illustration and not limitation, the task can comprise, for example, the inspection of a home or other building, structure, or property by (certified or otherwise licensed) home inspectors or other service professionals. According to such an illustration, the task parameters 107 can comprise, for example, specifications of the home or building, such as, for example, the total square footage of the home or building or other defining characteristic of such properties from which the total time to perform the inspection can be calculated or otherwise determined. According to an alternative illustration, if the task is to shop for groceries or other goods, then the task parameters 107 can include such information as, for example, the number and types of items to purchase, the number of stores to visit and other like information. Those of ordinary skill will recognize that exemplary embodiments of the present invention can be configured to schedule appointments for any such suitable tasks.

The task time generation module 105 can calculate or otherwise determine the total (or approximate total) time to perform the task in any suitable manner. For example, the task time generation module 105 can be comprised of suitable algorithms, Boolean or other logic functions or rules, neural networks, and/or forms of artificial intelligence that are capable of learning information about a task and, based on that information, formulate time estimates for performing the task. According to one exemplary embodiment, the task time generation module 105 can include appropriate look-up tables that can map task parameters 107 to total time estimates. Such look-up tables can be stored in a suitable computer memory or other computer storage device internal to or in communication with the task time generation module 105. For purposes of illustration and not limitation, if the task is a home inspection, and the task parameter 107 comprises the total square footage of the home, then the look-up table can include a mapping of total square footage to time estimates for one home inspector to perform an inspection of a home with such a total square footage. For example, for a 1000 square foot property, it could take one inspector a total of one hour to inspect the home, while a 2000 square foot property could take one inspector a total of two hours to inspect the property or two inspectors a total of one hour to perform the inspection, and the like. The complexity of such look-up tables will depend on the nature and type of task(s) and task parameters 107. For example, continuing with the present illustration, if the home has a total of 1000 square feet of floor space, but an attic with a small crawl space (e.g., as indicated by the user), it could take one inspector a total of 1.25 hours to inspect the home.

Alternatively, suitable Boolean or other logic or rules can be used to generate the time estimates based on the task parameters 107. For example, continuing with the present illustration, Boolean logic can be used to determine that IF the total square footage is 1000 square feet AND one inspector is to perform the inspection, THEN the estimated total time to perform the inspection is one hour. The complexity of such logic or rules will depend on the nature and type of task and the quantity and types of task parameters 107 that can be inputted by the user for such a task, as well as other like factors. More complex mechanisms, such as neural networks, can be adapted to “learn” how to respond to inputted task parameters 107 for a task. For example, according to an exemplary embodiment, the task time generation module 105 can “learn” that it takes 1.25 hours for one inspector to perform a home inspection of a home with a total of 1000 square feet of floor space, but that has a small crawl space in the attic that slows the inspection process. Such information can be fed back to the task time generation module 105 to allow such “learning” to take place and to refine these or other task time generation algorithms.

Additionally, exemplary embodiments of the present invention can be configured to evaluate the task parameters 107 differently based on each entity that can perform the task. For example, continuing with the present illustration, it may take one inspector one hour for inspecting a 1000 square foot building, while another inspector may take 1.5 hours for inspecting the same 1000 square foot building. Such differences in the time it takes each entity to perform the task can be suitably factored into the determination of the total time to perform the task, for example, by including appropriate entries in the aforementioned look-up table. For example, the look-up table can include a mapping of total square footage to time estimates for each home inspector to perform an inspection of a home with such a total square footage. Thus, exemplary embodiments can be configured to evaluate the task parameters 107 differently on a per-entity basis.

As used herein, an “entity” can be an individual, such as, for example, a service professional or other person capable of performing the task (including the users themselves), a company, or any other suitable type of entity capable of performing a task or for which a task can be performed. For example, an “entity” can comprise equipment (e.g., a tractor, a tool, or the like), a conference room (e.g. scheduling an conference room closest to a hotel), or the like. Thus, exemplary embodiments of the present invention can be used with a variety of tasks and entities, ranging from, for example, scheduling a service professional for an appointment to, for example, scheduling or otherwise reserving a piece of equipment or other good, product, or service.

The system 100 includes an availability determination module 110 in communication with the task time generation module 105. The availability determination module 110 is configured to generate a list of entities available for performing the task (including the dates/times that each entity is available) in accordance with or otherwise based on, for example, the total time for performing the task as determined by the task time generation module 105, the schedules of each of the entities, and a date/time window(s) specified by the user. Other factors can be used by the availability determination module 110 to generate the list of available entities, such as, for example, whether or not the entity is configured to perform the task type and other like factors. The list of available entities can be generated by the availability determination module 110 based on other additional and/or alternative factors, such as, for example, the travel time to/from the task site (as discussed in more detail below), rules on whether or not an entity can perform the task(s), and other like factors, information, rules and the like. Thus, the availability determination module 110 can receive the total time for performing the task from the task time generation module 105. The availability determination module 110 can also maintain a list of all entities that can perform the task.

For purposes of illustration and not limitation, the availability determination module 110 can maintain the list of, for example, all home inspectors for a home inspection company and the schedules of each of those inspectors. For example, if the home inspection company employs two inspectors, Bugs B. and Daffy D., the availability determination module 10 can store or otherwise retrieve information that, for example, Bugs B. is available Monday through Friday from 8:00 am to 5:00 pm, except Tuesdays from 12:00 pm to 1:00 pm, and Daffy D. is available Tuesday and Thursday from 9:00 am to 4:30 pm, except Thursdays from 2:00 pm to 3:00 pm. According to an exemplary embodiment, such information can be maintained by the availability determination module 110 in suitable look-up tables or the like that can be stored in an appropriate computer memory or other computer storage device internal to or in communication with the module. However, such information can be maintained or otherwise stored by the availability determination module 110 using any suitable type of computer storage mechanism or manner.

As one of the task parameters 107 provided by the user, the user can also supply one or more date/time windows or deadlines during or before which the user would like the task performed. Each date/time window can comprise a requested date and time and, if necessary, a length of time within which the user desires to create a “window of opportunity” to have the task performed. For purposes of illustration and not limitation, a user could specify that they would like to have a home inspection performed on either Tuesday at 2:00 pm or Thursday at 2:00 pm. Alternatively, the user could specify that they would like to have the home inspection performed at any time before a “required by” date of Thursday.

Assume for purposes of the present illustration that the user has specified that the home has 1000 square feet of floor space, and the task time generation module 105 has calculated that it would take one inspector a total of one hour to perform the inspection. Using the total task time, the schedules of Bugs B. and Daffy D., and the date/time windows specified by the user (e.g., either Tuesday at 2:00 pm or Thursday at 2:00 pm), the availability determination module 110 can determine or otherwise “look-up” that either Bugs B. or Daffy D. is available on Tuesday at 2:00 pm, but only Bugs B. is available on Thursday at 2:00 pm (as Daffy D. is not available on Thursdays from 2:00 pm to 3:00 pm). Such information on the available entities and appointment times can be displayed to the user for scheduling the appointment. Although look-up tables or the like can be used to generate such lists, those of ordinary skill in the art will recognize that suitable Boolean or other logic or rules or other more complex mechanisms (e.g., neural networks or the like) can additionally or alternatively be used to generate the list of available entities. The availability list for the specified date/time windows can then be graphically presented to the user for selection of an entity (or entities) to perform the task.

According to an exemplary embodiment, the availability determination module 110 can include a geographical proximity scheduling module 112. The geographical proximity scheduling module 112 can be configured to sort the list of available entities (and corresponding available appointment times for each entity) in geographic order in accordance with travel times to and from the task site. The geographical proximity scheduling module 112 includes appropriate rules or other logic that are applied when determining the geographic sort order of available entities/appointment times to display to a user when scheduling an appointment within a specified date/time window. Travel times can be calculated between the task site for the appointment being scheduled and other locations on the entity's calendar. Such other locations on the entity's calendar can be either task sites for other appointments or geographic anchors, such as, for example, a start of business address or a close of business address. The geographical proximity scheduling module 112 then applies a suitable weighting based on, for example, whether or not the travel time is between two appointments or between an appointment and another geographic anchor. Appointment-to-appointment travel times can receive a higher weighting than other travel times.

After the availability determination module 110 has determined the available times for each available entity, the geographical proximity scheduling module 112 can then sort the available appointments in geographic order by, for example, comparing the travel times to and from the task site. The geographical proximity scheduling module 112 can use suitable rules when comparing two available appointments. According to an exemplary embodiment, such rules can include the following: i.) if neither of the available appointments has an appointment-to-appointment travel time, then the available appointments can be sorted by their start date and time; ii.) if both available appointments have an appointment-to-appointment route, then the maximum appointment-to-appointment routes for each available appointment can be compared, and the available appointment with the shorter of the maximum routes can be sorted above the other or otherwise given a higher sort position in the list (e.g., nearer the beginning or top of the sort list); iii.) if one available appointment has an appointment-to-appointment route and the other does not, then the maximum appointment-to-appointment route for the one appointment can be compared to the maximum route for the other appointment, and the available appointment with the shorter route of the two can be sorted above the other or otherwise given a higher sort position in the list; iv.) if both available appointments have an appointment-to-appointment route, then the maximum appointment-to-appointment routes for these appointments can be compared to each other, and the appointment with the shortest maximum route can be sorted above the other appointment or otherwise given a higher sort position in the list. Such a rules-based comparison can be used to sort all available appointments into geographical proximity order (e.g., as a type of “bubble sort,” such that the available appointments with the shorter geographical proximity “bubble” to the beginning or top of the list). Other suitable rules, algorithms, or procedures can be used to compare and geographically sort the available appointments.

The system 100 provides the capability of flexibly scheduling times for appointments based on the needs of the user. For example, the availability determination module 110 can be configured to perform RIGHT NOW SCHEDULING™ to schedule an entity for a task on-demand to swiftly satisfy a user request. According to an exemplary embodiment, locations of entities can be tracked via GPS or other suitable tracking technology in real-time or substantially real-time (e.g., through short intervals), and such tracking information can be communicated to the availability determination module 110. For example, when the system 100 receives a request to schedule an appointment that needs to be scheduled for immediate service, the availability determination module 110 can use the tracking information to identify the entity that is both closest to the location of the task site and can perform the requested task, and then schedule that entity to perform the task.

Suitable rules and/or logic can be used to identify such available entities. According to an exemplary embodiment, the following rules can be applied by the availability determination module 110 when identifying an available entity to perform the task: a.) the entity must be able to complete its current task and arrive at the newly requested task site within the identified time window that is specified by the user; b.) the entity must be available for the newly created task by applying one of the following rules/processes:
i.) the entity must either not have any additional tasks to perform in the day after their current task; or
ii.) the remaining tasks in the day must be marked as optional; or
iii.) there must be a time window where the entity can perform the new task and still be able to perform the remaining tasks in the day; or
iv.) there must be other entities available that can backfill the appointments that the entity will not be able to fulfill in order to fulfill the on-demand task;
   c.) the entity must receive a request to fulfill the on-demand task and respond with an acknowledgement within a configurable response-time window—if this request/response is not received within the configurable response-time window, then the availability determination module 110 can search for another entity to fulfill the on-demand task. Other configurable factors can be applied in such a decision tree, such as, for example, whether or not the entity is carrying the correct equipment to perform the task, and other like factors.

As discussed previously, the availability determination module 110 can attempt to backfill an entity's other appointments to cover for the on-demand appointment so that all original appointments are fulfilled. Such backfilling can occur on a cascading basis, with the first geographic anchor being the first appointment to backfill. For example, the availability determination module 110 can find the closest other entity that can fulfill the appointment to backfill, and appropriately schedule that other entity to backfill for the appointment. If configured to do so, the availability determination module 110 can require an acknowledgment from the other entity before scheduling that other entity for the appointment. The other entity that is selected to backfill for the appointment can then have other appointments that they need to have backfilled, because, for example, those other appointments had a large geographic separation from their current location and from the appointment they are not backfilling. As a result, the availability determination module 110 can repeat the aforementioned rules/processes to backfill the appointments for all entities that have been rescheduled, because of their geographic proximity to appointments that need backfilling, until the schedule for all entities in or near the region have been refined and all appointments have been backfilled.

In the event that there are not enough available timeslots for the availability determination module 110 to backfill all appointments, then the following rules can be applied by the availability determination module 110: a.) the availability determination module 110 will postpone appointments that are configured as optional in order to schedule all mandatory appointments for the day; b.) in the event that the availability determination module 110 is unable to backfill all appointments, the user will be notified so that more entities can be deployed to the area. Once all of the appointments have been reshuffled for geographic optimization (as discussed previously), then a notification can be sent to all entities who have had their appointments changed. The notification can include such information as, for example, the new route information for all remaining appointments for the day, as well as all information required for each appointment. The system 100 can also provide a notification to, for example, office staff and/or call center personnel so that they have up-to-date route and appointment information for all entities. In such a manner, exemplary embodiments of the present invention can flexibly schedule appointments to perform a desired task at a desired time, with or without sufficient prior notice from the user.

The system 100 includes an appointment module 115 in communication with the availability determination module 110. The appointment module 115 is configured to schedule an appointment for performing the task within the date/time window in accordance with the user selection of at least one entity from the list of available entities. Assume for purposes of the present illustration that the user has selected Bugs B. to perform the home inspection on Tuesday at 2:00 pm. The appointment module 115 can then generate an inspection appointment (e.g., home inspection, Bugs B., Tuesday at 2:00 pm, at user's home) based on the user's inspector selection indication of Bugs B. The process can be repeated any appropriate number of times to schedule any suitable number of appointments by the user for each and any entity.

The system 100 can include a fee determination module 120. The fee determination module 120 can be configured to determine the total (or substantially total) fee for the appointment in accordance with or otherwise based on the task parameters 107 provided by a user. The fee determination module 120 can calculate or otherwise determine the total (or approximate total) fee for the appointment in any suitable manner. For example, the fee determination module 120 can be comprised of suitable algorithms, Boolean or other logic functions or rules, neural networks, and/or forms of artificial intelligence that are capable of learning information about a task and, based on that information, formulate fee estimates for the appointment. According to one exemplary embodiment, the fee determination module 120 can include appropriate look-up tables that can map task parameters 107 to fee calculations. Such look-up tables can be stored in a suitable computer memory or other computer storage device internal to or in communication with the fee determination module 120.

For purposes of illustration and not limitation, if the task is a home inspection, and the task parameter 107 comprises the total square footage of the home, then the look-up table can include a mapping of total square footage to fees for one home inspector to perform an inspection of a home with such a total square footage. The total fees can be based on the hourly rate of the inspector and the time to perform the inspection. Assume for purposes of the present illustration that the hourly rate of each inspector is $125. For example, for a 1000 square foot property, it could take one inspector a total of one hour to inspect the home, corresponding to a fee of $125. However, a 2000 square foot property could take one inspector a total of two hours ($125×2) to inspect the property or two inspectors a total of one hour ($125+$125) to perform the inspection, generating a total fee in either instance of $250. The complexity of such look-up tables will depend on the nature and type of task(s) and task parameters 107. For example, continuing with the present illustration, if the home has a total of 1000 square feet of floor space, but an attic with a small crawl space (e.g., as indicated by the user), it could take one inspector a total of 1.25 hours to inspect the home, for a total fee of $125×1.25=$156.25. Such look-up tables can include additional fee information that can be factored into the fee calculation, such as fees for ancillary or special services, travel and/or equipment expenses, or the like, and such additional fee information can be added to the fee estimates to generate an estimated total fee for performing the task.

Alternatively, suitable Boolean or other logic or rules can be used to generate the fee estimates based on the task parameters 107. For example, continuing with the present illustration, Boolean logic can be used to determine that IF the total square footage is 1000 square feet AND one inspector takes one hour to perform the inspection, THEN t the estimated total fee to perform the inspection is $125. The complexity of such logic or rules will depend on the nature and type of task and the types of task parameters 107 that can be inputted by the user for such a task, as well as other like factors. More complex mechanisms, such as neural networks, can be adapted to “learn” how to respond to inputted task parameters 107 to generate total fees for the appointment. More complex mechanisms, such as neural networks, can be adapted to “learn” how to generate fee estimates for an appointment. For example, according to an exemplary embodiment, the fee determination module 120 can “learn” that it actually costs $150 for one inspector to perform a home inspection in one hour for a home with a total of 1000 square feet of floor space, but that has a small crawl space in the attic that makes the inspection process more difficult. Such information can be fed back to the fee determination module 120 to allow such “learning” to take place and to refine these or other fee determination algorithms.

According to an alternative exemplary embodiment, the fee determination module 120 can be in communication with or form a part of the task time generation module 105. In such an alternative configuration, the fee determination module 120 can be configured to determine the total (or substantially total) fee for performing the task in accordance with or otherwise based on the total time received from the task time generation module 105.

The appointment module 115 can also be configured to receive payment or other appropriate financial transaction information from the user (e.g., credit card information, electronic fund transfers, or the like) for processing and tracking the payment of the fees determined by the fee determination module 120. Additionally, the appointment module 115 can be configured to maintain and provide suitable contractual information (e.g., describing the terms and conditions of performance of the task) for review and acceptance by the user prior to scheduling the appointment.

The appointment module 115 can be configured to perform multi-party scheduling. According to an exemplary embodiment, multi-party scheduling involves combining appointments for a user from multiple, disparate, disconnected entities, such as, for example, different companies that perform different services. Such disparate entities are related insofar as they provide their services in the same geographic area as each other. Multi-party scheduling can allow a user to schedule multiple types of services from multiple entities so that all of the services can be performed on a task site at the same time, thus eliminating the need for the user to oversee various vendors at different times.

The multi-party scheduling performed by the appointment module 115 can leverage information from the geographical proximity scheduling module 112, fee calculations from the fee determination module 120, and appointment duration calculations from the availability determination module 110 to retrieve and organize all available appointments for each entity. The appointment module 115 can then use the multi-party scheduling to combine the available appointments for each entity, where the available appointment times either match perfectly or overlap. These combined appointments can be considered an available appointment set. Each available appointment set can be given a cost rating based on suitable factors, such as, for example, the following: a.) how high the appointment ranks on each entity's geographic proximity order; and b.) how well the start and end times for each appointment match each other, e.g., a higher cost is applied the greater the start and end times overlap. Lower cost appointment sets can be sorted above (or closer to the beginning or top of the list than) higher cost appointment sets so that the user is presented with the lower cost appointment sets before they are presented with the higher cost appointment sets. Such a cost rating can provide value to both the user that is scheduling the entities and to the entities that are being scheduled. For example, the benefit to the user is that they are presented with appointments that do not overlap—or overlap the least—at or near the top of the list. The benefit to each entity is that they have appointments that are located in geographic proximity to other appointments on their calendar that are presented at or near the top of the available appointment list.

The system 100 can include a storage or database module 125 in communication with the appointment module 125. The storage module 125 can be configured to maintain or otherwise store any suitable information used or generated by the system 100. For example, the storage module 125 can be configured to store the schedule of appointments or other calendar information, user-related information (e.g., name, address, account number and the like), task parameters 107, time and fee estimates, schedules of entities, the generated lists of available entities for each task, and other suitable information. The storage module 125 can be comprised of any suitable type of computer-readable or other computer storage medium capable of storing information in electrical or electronic form.

The system 100 can include a display module 130 in communication with the appointment module 115. The display module 130 is configured to display graphical and/or textual information to the user. For example, the display module 130 can be configured to display the schedule of available appointments to the user. Additionally, the display module 130 can be a portal or interface through which the user provides or otherwise enters the task parameters 107 for use by the system 100. The display module 130 can be comprised of any suitable type of user interface capable of displaying graphical and/or textual information to a user. For example, the display module 130 can be configured to display an appointment schedule, or any other appropriate information generated by the system 100, through a suitable Web browser (e.g., Internet Explorer, Netscape, Firefox, Safari, Opera, or any other suitable Web browser) on any appropriate type of display, such as a computer monitor or other display device (e.g., a personal digital assistant (PDA) or the like portable display).

The system 100 can include a communication module 135 in communication with the appointment module 115. The communication module 135 is capable of communicating appropriate information to and from the system 100 via, for example, any suitable type of network 140, such as, for example, an intranet, an internet (e.g., the Internet or World Wide Web) or the like. For example, the communication module 135 can be used to communicate information to and from the users, the entities performing the tasks, or other systems (e.g., remote databases, information systems or the like for obtaining information for use by or supplying information generated from the system 100). According to an exemplary embodiment, the appointment module 115 can be configured to communicate an appointment confirmation to appointment participants (e.g., after the appointment has been scheduled by the appointment module 115) via the communication module 135. For example, an e-mail or other appropriate electronic message can be communicated to the appointment participants confirming the appointment, and can include such information as, for example, the appointment particulars, contact information, and the like. As used herein, an “appointment participant” can include any entity associated with an appointment, including, but not limited to, the user, the entity, an agent representing the user, a seller of a property, a transaction coordinator, a relocation coordinator, or the like. According to an exemplary embodiment, an initial confirmation can be sent, and further reminders can be sent at a later, predetermined interval (e.g., 36 hours later or at any desired time). In addition, each day the entity can receive their schedule of appointments for the following day. Other like information can be communicated to users, entities, or other appointment participants using the communication module 135.

Once a task is completed, the entity may have information to report to the user concerning the performance and completion of the task, such as a task report or other findings, observations, conclusions, or the like. For purposes of illustration and not limitation, a home inspector can send the findings of the home inspection to the user upon completion of the inspection. Accordingly, the system 100 can include a report or artifact delivery module 145 that can be in communication with the appointment module 115. The artifact delivery module 145 can be configured to communicate artifacts resulting from an entity performing a task. As used herein, an “artifact” can be any suitable type of information, such as a report, record, or the like, that is associated with a task. The artifact delivery module 145 can work in conjunction with the payment tracking and contractual information functionality provided by the appointment module 115. The artifact delivery module 145 can also allow an authorized entity to upload the artifact to the system 100.

The artifact can be available to the user based on appropriate rules, such as, for example, the following: a.) if the entity is configured to not require payment, and not to require a (signed or accepted) contract from the user before delivering the artifact(s), then the artifact is available to the user; or b.) if the entity is configured to require payment, to not require a (signed or accepted) contract, and the service has been paid for by the user, then the artifact is available to the user; or c.) if the entity is configured to require a (signed or accepted) contract, to not require payment, and the contract has been received from the user, then the artifact is available to the user, or d.) if the entity is configured to require both a (signed or accepted) contract and a payment, and both the contract and payment have been received from the user, then the artifact is available to the user. If none of the aforementioned rules or conditions are met, then the artifact will be unavailable to the user until the user satisfies the appropriate conditions. When the conditions are met and the artifact is made available to the user, then the artifact can be delivered by suitable electronic means, such as by e-mail, facsimile, download, or the like (e.g., via communication module 135). For example, if the entity is sending the artifact(s) by e-mail, then the entity can configure the desired e-mail attachment size used by the system 100. If there are multiple artifacts to be delivered via e-mail, then the artifact delivery module 145 can send multiple e-mails to keep the attachment size under or near the configured attachment size. The entity can also customize the e-mails that are delivered to each user. For example, the e-mails can be configured to include the artifact as an attachment or as a link to an address (e.g., a network or IP address, URL, or the like) where the user can download the artifact. A separate e-mail can be customized to notify the user that the artifact(s) is/are available, but is not deliverable until the appropriate condition(s) is/are satisfied.

The system 100 can include a workflow management module 150 in communication with the appointment module. The workflow management module 150 can be configured to manage task workflows for an appointment. Each task can have various ancillary responsibilities, actions, events, and other activities that are to be performed as part of the task. According to exemplary embodiments, the workflow management module 150 can manage not only the task, but also any and all related activities and events that must be performed by the entity to accomplish the task. For purposes of illustration and not limitation, if the task is carpet cleaning, then such ancillary responsibilities can include, for example, purchasing carpet shampoo, and the like. When an appointment is scheduled, the workflow management module 150 can also schedule the associated events for the entity to perform to manage the task. For example, the workflow management module 150 can create an ancillary task in the system 100 to obtain credit card information from the user to ensure payment for a home inspection. In such a manner, the workflow management module 150 can manage the business flows and processes for any suitable task.

According to exemplary embodiment, the workflow management module 150 can include appropriate look-up tables that can map a task to associated task activities and events. Such look-up tables can be stored in a suitable computer memory or other computer storage device internal to or in communication with the workflow management module 150. For purposes of illustration and not limitation, if the task is the stain treating of furniture, then the look-up table can include a mapping of the task of furniture stain treating to the associated activity of purchasing stain for use in the task. The complexity of such look-up tables will depend on the nature and type of each task and the activities and events associated with each task. Alternatively, suitable Boolean or other logic or rules can be used to generate the ancillary task activities and events based on the task to be performed. For example, continuing with the present illustration, Boolean logic can be used to determine that IF the task is carpet cleaning, THEN the ancillary activity is purchasing carpet shampoo. The complexity of such logic or rules will depend on the nature and type of task and associated activities and events, as well as other like factors. More complex mechanisms, such as neural networks, can be adapted to “learn” how to respond to each task. For example, according to an exemplary embodiment, the workflow management module 150 can “learn” that carpet shampoo must be purchased before the carpet cleaning task can be performed. Such information can be fed back to the workflow management module 150 to allow such “learning” to take place and to refine these or other workflow management algorithms.

Additionally or alternatively, the appointment module 115 can be configured to communicate other information, such as, for example, an appointment reminder to each entity (and/or the user) for each appointment (e.g., on the day of or shortly before the appointment) via the communication module 135. According to exemplary embodiments, different types of reminders can be sent to the entity (e.g., the service professional) and the appointment participants. For example, if sent to each entity, the appointment reminder can include a log or other daily schedule of all or substantially all appointments for that day for that entity, as well as, for example, task details for each appointment. Such information can be communicated to the entities via an appropriate messaging mechanism, such as, for example, e-mail, text message, instant message, or other like electronic information delivery system or method. In such a configuration, the appointment module 1 15 can serve as a calendar module to inform and remind entities and users of appointments and information related to or otherwise associated with those appointments. Accordingly, the appointment reminder can include any suitable information for informing or otherwise reminding entities and users of appointments, and can include one or more messages customized for each entity, user, or other resource (e.g., as a customized e-mail or text message).

According to an exemplary embodiment, the appointment reminder can include travel directions for appointments, including to and from and between such appointments. For example, travel directions are available via the World Wide Web from websites such as MAPQUEST™, YAHOO™, GOOGLE™, MSN™ and the like. Accordingly, the availability determination module 110 can communicate with such websites via the communication module 135 over network 140 to provide to those websites, for example, start and end addresses for desired locations. The corresponding travel directions received from the websites in response to the proffered addresses can be electronically forwarded to a recipient (e.g., as an e-mail attachment or the like) by either the availability determination module 110 or the appointment module 115 via the communication module 135.

The travel directions provided by such sites can also include estimated travel times between the starting and ending addresses. Accordingly, the availability determination module 110 can be configured to determine the travel time to and from a task site in accordance with the address of the task site. For example, the availability determination module 110 can be configured to appropriately parse the travel directions (e.g., by searching for a unique string of characters or other designation indicative of the travel time) to recover the travel time. The availability determination module 110 can be configured to include such travel time in generating the list of available appointments. For example, if the travel time to a task site is long, the availability determination module 110 can increase the length of the appointment to include the additional travel time. For purposes of illustration and not limitation, assume the user has used the system 100 to schedule a home inspection appointment with Bugs B. on Tuesday at 2:00 pm, and the inspection is calculated to last one hour. The availability determination module 110 can query an appropriate travel direction website or other appropriate information source using the starting address of the central office (e.g., the address of the inspection company) and the ending address of the user's home (as provided by the user) to obtain suitable travel directions. In parsing the travel directions, the availability determination module 110 can obtain the travel time of, for example, 30 minutes.

Accordingly, the availability determination module 110 can determine that the home inspector should start traveling to the appointment at 1:30 pm to ensure that the home inspector has sufficient travel time to arrive at the user's home at the user's designated appointment time of 2:00 pm (assuming that such schedule augmentation conforms to the entity's schedule as maintained by the availability determination module 110). The availability determination module 110 is configured to ensure that there is adequate travel time between the previous location (either another appointment or perhaps a start of business address) and the start of the appointment time. For example, the entity can have a start of an appointment time that is potentially earlier (e.g., 1:30 pm) than the appointment time of the user (e.g., 2:00 pm), as the entity's appointment time includes sufficient travel time (e.g., 30 minutes) for the entity to reach the task site of the user to promptly meet the user's scheduled appointment. Skilled artisans will recognize that travel directions and travel times can be generated in other suitable manners without reliance on such external websites, such as, for example, by using other proprietary commercial databases or other suitable software programs. Additionally, such travel information can be also be used by the geographical proximity scheduling module 112.

According to an additional exemplary embodiment, the availability determination module 110 can be configured to receive a travel offset for modifying the travel time to and from the task site. For example, the estimated travel time used by the availability determination module 110 may not be an accurate reflection of the actual time it may take to reach a task site due to such factors as, for example, traffic, weather conditions, and the like. Accordingly, a travel offset can be input into the availability determination module 110 to modify the time length of the travel time in accordance with the travel offset. For example, the travel offset can be added to the (estimated) travel time to produce an updated travel time. Such an updated travel time can then be used by the availability determination module 110 to appropriately display available appointments. The travel offset can be input either automatically by the system 100 (e.g., by receiving suitable information from a remote source, such as traffic or weather news feeds or the like) or manually by a user of the system 100 (e.g., via the display module 130).

The availability determination module 110 can maintain information related to the location of task sites, travel directions to and from such sites, as well as the corresponding travel times. As discussed previously, the availability determination module 110 can be configured to generate a list of appointments ranked in order of geographic proximity to a predetermined location (e.g., a central office or other place of origin) or to another appointment on the entity's calendar (e.g., for purposes of route optimization). The ranking can be based on for example, the travel times to each site, with the sites with the shortest travel time listed at or near the top of the list and those with longer travel times listed at or near the bottom of the list (or vice versa). Additionally or alternatively, with such travel information, the availability determination module 110 can be configured to optimize the travel schedule for each entity in accordance with the geographical locations of appointments for each day. The availability determination module 110 allows a start of business address and a close of business address to be input, and can calculate the travel time from those geographical anchors. Such travel times can be included in the geographical proximity ranking (as determined by, for example, the geographical proximity scheduling module 112), although with a lower ranking than an appointment-to-appointment travel time. In other words, the availability determination module 110 can be configured to prioritize, rank or otherwise organize or arrange available appointment schedules using information obtained from suitable sources, such as, for example, travel directions/travel times, traffic conditions, weather conditions, and the like, to maximize scheduling efficiency.

For some tasks, it may be necessary to schedule more than one entity to perform the task, particularly if the task is large. In scheduling appointments, the availability determination module 110 can be configured to assign a plurality of entities for the appointment. For example, in the lookup-tables maintained or other algorithms used by the availability determination module 110, if a task time exceeds a predetermined threshold, two or more entities can be scheduled for the appointment. For purposes of illustration and not limitation, for a 3000 square foot home, it can take one inspector a total of three hours to inspect the home. However, assume that it takes two inspectors only 1.5 hours to inspect such a property. To more efficiently schedule inspection time, the availability determination module 110 can be configured to schedule two inspectors to inspect any property that requires more than three hours to be inspected by a single inspector. For example, such information can be maintained in the suitable look-up table maintained by the availability determination module 110, or an appropriate comparison can be made with the total time generated by the task time generation module 105 and the predetermined threshold. Any appropriate number of entities can thereby be assigned or otherwise scheduled to perform a task in the most time-efficient manner possible.

According to exemplary embodiments, the appointments are maintained by the appointment module 115, whereas the availability determination module 110 includes the rules or other conditions for determining which appointments are available based on the appointments maintained by the appointment module 115. However, based on the schedules of entities maintained by the appointment module 115, no single entity may be available to perform the task within the date/time window provided by the user. However, the availability determination module 110 can be configured to allot a portion of the appointment to each of a plurality of entities. For purposes of illustration and not limitation, a user requests a home inspection appointment at a certain day and time that is calculated to take one hour to complete. However, the availability determination module 110 determines that neither Bugs B. nor Daffy D. individually are available for that entire hour. However, based on their schedules, Bugs B. is available for the first 30 minutes of the hour, and Daffy D. is available for the second 30 minutes of the hour. Thus, such information can be provided to the availability determination module 110 to schedule Bugs B. to perform the home inspection for the first 30 minutes of the appointment and Daffy D. for the second 30 minutes of the appointment, thereby completing the inspection within the user's desired date/time window. Any suitable number of entities can be allotted portions of an appointment to ensure the task is completed on time. Of course, if no entity is available during the date/time window specified by the user, the availability determination module 110 can be configured to suggest or otherwise propose alternative days and/or times (e.g., near the user's requested date/time) for scheduling the appointment to perform the task.

Each of modules of the system 100, including the task time generation module 105, availability determination module 110, geographical proximity scheduling module 112, appointment module 115, fee determination module 120, storage module 125, display module 130, communication module 135, artifact delivery module 145, workflow management module 150, or any combination thereof, can be comprised of any suitable type of electrical or electronic component or device that is capable of performing the functions associated with the respective element. According to such an exemplary embodiment, each component or device can be in communication with another component or device using any appropriate type of electrical, electronic, or digital connection that is capable of carrying electronic or digital information. Alternatively, each of the modules of the system 100 can be comprised of any combination of hardware, firmware and software that is capable of performing the functions associated with the respective module.

Alternatively, the system 100 can be comprised of one or more microprocessors and associated memory(ies) that store the steps of a computer program to perform the functions of any or all of the modules of the system 100. The microprocessor can be any suitable type of processor, such as, for example, any type of general purpose microprocessor or microcontroller, a digital signal processing (DSP) processor, an application-specific integrated circuit (ASIC), a programmable read-only memory (PROM), an erasable programmable read-only memory (EPROM), an electrically-erasable programmable read-only memory (EEPROM), a computer-readable medium, or the like. The memory can be any suitable type of computer memory or any other type of electronic storage medium, such as, for example, read-only memory (ROM), random access memory (RAM), cache memory, compact disc read-only memory (CDROM), electro-optical memory, magneto-optical memory, or the like. As will be appreciated based on the foregoing description, the memory can be programmed using conventional techniques known to those having ordinary skill in the art of computer programming to perform the functions of any or all of the modules of the system 100. For example, the actual source code or object code of the computer program can be stored in the memory.

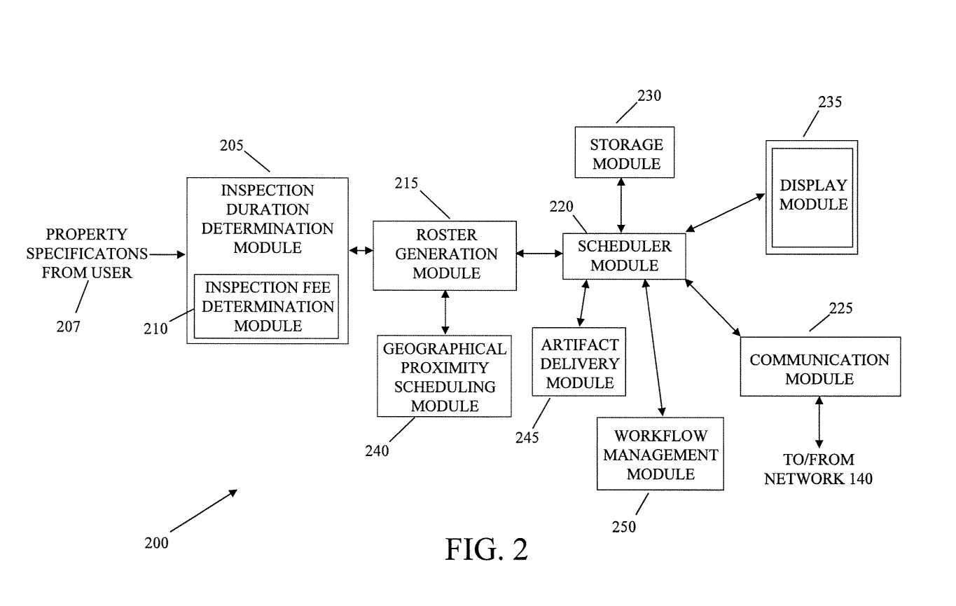

Alternative architectures or structures can be used to implement the various functions of the system 100 as described herein. For example, functions from two or more modules can be implemented in a single module, or functions from one module can be distributed among several different modules. In particular, the implementation of the functions of the system 100 can depend on the tasks for which appointments are to be scheduled. Merely for purposes of illustration and not limitation, FIG. 2 is a block diagram illustrating a system 200 for automatically scheduling appointments for inspecting a property, in accordance with an alternative exemplary embodiment of the present invention.

The system 200 includes an inspection duration determination module 205. The inspection duration determination module 205 is configured to determine the total inspection time for inspecting the property, building, structure, or the like in accordance with specifications 207 of the property provided by the user. For example, the specifications 207 of the property can include the total square footage of the property, as well as any other suitable information associated with the property (e.g., number of rooms, number of floors, whether the basement and/or attic are finished, any unusual structural characteristics of the property, and the like). The inspection duration determination module 205 can determine the total inspection time in a manner similar to that discussed previously with respect to the task time generation module 105 illustrated in FIG. 1, so such a discussion will not be repeated. The inspection duration determination module 205 can include an inspection fee determination module 210 that is configured to determine the (total or substantially total) fee for inspecting the property in accordance with the specifications 207 of the property provided by the user. The inspection fee determination module 210 can determine the inspection fees in a manner similar to that discussed previously with respect to the fee determination module 120 illustrated in FIG. 1, so such a discussion will not be repeated.

The system 200 includes a roster generation module 215 in communication with the inspection duration determination module 205. The roster generation module 215 is configured to generate a list of inspectors available to inspect the property in accordance with, for example, the total inspection time, the schedules of the inspectors, and an inspection schedule window(s) specified by the user. Other factors can be used by the roster generation module 215 to generate the list of available inspectors, including, but not limited to, the travel time to/from the inspection site, whether or not the inspector can perform the requested task(s), and any other suitable factors. The roster generation module 215 is also configured to receive an inspector selection indication from the user for selecting at least one of the available inspectors. The roster generation module 215 can generate the list of available inspectors in a manner similar to that discussed previously with respect to the availability determination module 110 illustrated in FIG. 1, so such a discussion will not be repeated.

The system 200 can include a geographical proximity scheduling module 240 in communication with the roster generation module 215. The geographical proximity scheduling module 240 is configured to sort the list of available inspectors in geographic order in accordance with or otherwise based on the travel times to and from the property. The geographical proximity scheduling module 240 can perform such geo-coded sorting in a manner similar to that discussed previously with respect to the geographical proximity scheduling module 112 illustrated in FIG. 1, so such a discussion will not be repeated.

The system 200 includes a scheduler module 220 in communication with the roster generation module 215. The scheduler module 220 is configured to schedule an inspection appointment within the inspection schedule window in accordance with the inspector selection indication received from the user. The scheduler module 220 can perform the inspection appointment scheduling in a manner similar to the discussed previously with respect to the appointment module 115 illustrated in FIG. 1, so such a discussion will not be repeated.

The system 200 can include an artifact delivery module 245 in communication with the scheduler module 220. The artifact delivery module 245 can be configured to communicate artifacts resulting from an inspector performing an inspection. The artifact delivery module 245 can perform such artifact delivery in a manner similar to that discussed previously with respect to the artifact delivery module 145 illustrated in FIG. 1, so such a discussion will not be repeated. The system 200 can also include a workflow management module 250 in communication with the scheduler module 220. The workflow management module 250 can be configured to manage task workflows for or otherwise associated with an inspection appointment. The workflow management module 250 can perform such workflow management in a manner similar to that discussed previously with respect to the workflow management module 150 illustrated in FIG. 1, so such a discussion will not be repeated.

The system 200 can include a communication module 225 in communication with the scheduler module 220. The communication module 225 can be configured to communicate information via network 140 in a manner similar to that discussed previously with respect to the communication module 135 illustrated in FIG. 1, so such a discussion will not be repeated. The scheduler module 220 can be configured to communicate an inspection appointment confirmation to inspection appointment participants via the communication module 225. Such an inspection appointment confirmation can be customizable based on, for example, the role of the inspection appointment participant. Using the communication module 225, the scheduler module 220 can also be configured to communicate an inspection appointment reminder to each inspector (and/or the user) for each inspection appointment. According to an exemplary embodiment, the inspection appointment reminders can also be sent to each, any, or all inspection appointment participants, and can be in a format that is different than inspection appointment confirmation. If sent to each inspector, the inspection appointment reminder can include such information as, for example, a log or daily schedule of all or substantially all inspection appointments for a day for the inspector, travel directions for inspection appointments, one or more customizable messages, and other like information.

According to exemplary embodiments, the roster generation module 215 can be configured to determine travel time to and from the property (and between properties) in accordance with the address of the property in the manner discussed previously. Accordingly, the roster generation module 215 can be configured to include the travel time in scheduling the inspection appointment. The roster generation module 215 can also be configured to receive a travel offset for modifying the travel time to and from the property (and between properties) in the manner discussed previously. Consequently, the roster generation module 215 can be configured to modify the time length of the travel time in accordance with the travel offset. Using such travel direction and distance information, the roster generation module 215 can be configured to generate a list of inspection appointments ranked in order of geographical proximity to, for example, another appointment, either prior to or after the appointment to be scheduled, in the manner discussed previously. The roster generation module 215 can be further configured to optimize the travel schedule for each inspector in accordance with the geographical locations of the inspections appointments for each day to maximize the scheduling efficiency of each inspector. In addition, the roster generation module 215 can be configured to assign a plurality of inspectors for each or any inspection appointments, whether two or more inspectors are assigned to conduct the inspection together or allotting a portion of the inspection appointment to each of the plurality of inspectors.

The system 200 can include a storage module 230 in communication with the scheduler module 230. The storage module 230 can be configured to maintain or otherwise store any suitable information used or generated by the system 200, such as, for example, the schedule of inspection appointments or other like information generated or used by the system 200. The storage module 230 can be comprised of any suitable type of computer-readable or other computer storage medium capable of storing information in electrical or electronic form.

The system 200 can also include a display module 235 in communication with the scheduler module 220. The display module 235 is configured to display graphical and/or textual information to the user. For example, the display module 235 can be configured to display the schedule of available inspections appointments to the user. Additionally, the display module 235 can be a portal or interface through which the user provides or otherwise enters the property specifications 207 and other associated information for use by the system 200. The display module 235 can be comprised of any suitable type of user interface capable of displaying graphical and/or textual information to a user and receiving graphical and/or textual information from the user.

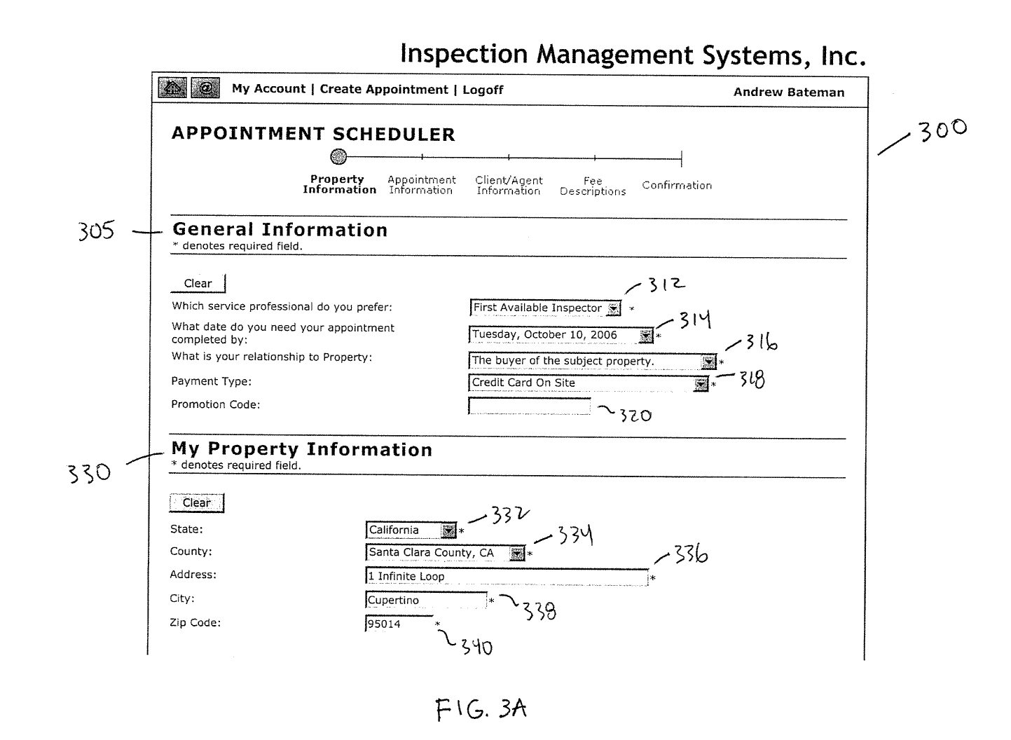

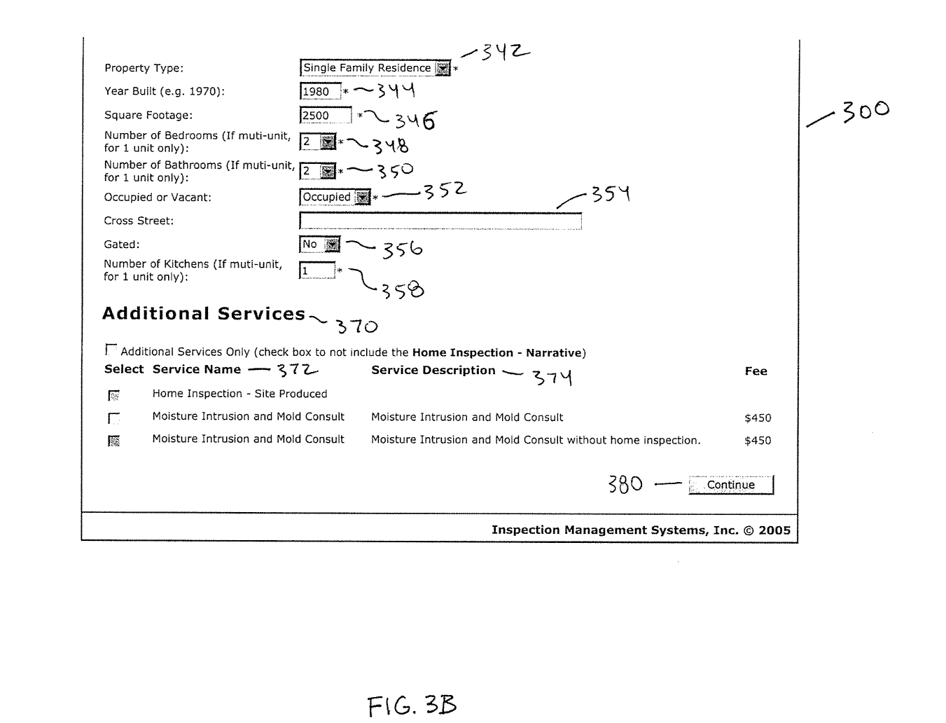

For example, FIGS. 3A and 3B are diagrams illustrating a first graphical user interface (GUI) 300 that can be displayed via the display module 235 for automatically scheduling appointments for inspecting a property, in accordance with an exemplary embodiment of the present invention. The first GUI 300 includes fields into which the user can enter information regarding the property to be inspected. Such fields can comprise blank fields into which the user can type or otherwise enter information, pull down menus, pop-up menus, radio or other buttons capable of being selected, or any other suitable form of field, form, button, or indicator into which the user is capable of entering appropriate information.

For example, the first GUI 300 can include general information fields 305. The general information fields 305 can include fields for entering any suitable type of general information regarding the user's property (e.g., information regarding the home, building, or other structure or property). For example, the general information fields 305 can include an inspector designation field 312. The inspector designation field 312 can be configured to allow the user to designate the name of the specific inspector (e.g., a particular home inspector from a particular home inspection company) that the user desires to have inspect the property, or can allow the system 200 to choose, for example, the first available inspector from a particular company. The general information fields 305 can include a date window field 314. The date window 314 can be configured to allow the user to designate the date and/or time in or by which the user desires to have the inspection completed. For purposes of illustration and not limitation, the date window field 314 illustrated in FIG. 3A has been changed by a user to indicate that the user needs the appointment completed by “Tuesday, October 10, 2006.”

The general information fields 305 can include a property relationship field 316. The property relationship field 316 can be configured to allow the user to designate the user's relationship to the property to be inspected. For purposes of illustration and not limitation, the property relationship field 316 can be comprised of an appropriate pull-down menu or the like that allows the user to select one of a predetermined number of selections, such as, for example, “the buyer of the subject property,” “real estate agent representing the buyer,” “the seller/owner of the subject property,” “owner,” “tenant,” “coordinator of the transaction,” “relocation coordinator for the transaction,” “lawyer representing the seller,” “lawyer representing the buyer,” “inspection company staff,” or any other suitable property relationship designation.

The general information fields 305 can also include a payment type field 318 for entering information on the type of payment that will be proffered by the user to pay for the inspection services. For purposes of illustration and not limitation, the payment type field 318 can be comprised of an appropriate pull-down menu that allows the user to select one of a predetermined number of selections, such as, for example, “check/cash,” “credit card on site,” “escrow billing,” “payment type is not known at this time,” or any other suitable payment type designation. A promotion or coupon code field 320 can be configured to allow the user to enter a promotion or coupon code that can be applied to the (calculated) total fees to reduce the total payment owed by the user for the inspection services.

The first GUI 300 can include property information fields 330. The property information fields 330 can include fields for entering any suitable type of information to uniquely identify the user's property that is to be inspected. For purposes of illustration and not limitation, the property information fields 330 can include such fields as, for example, a state designation field 332 (e.g., for designating the state in which the property resides), a county designation field 334 (e.g., for designating the county in which the property resides), a street address designation field 336 (e.g., for designating the street address of the property), a city designation field 338 (e.g., for designating the city in which the property resides), a zip code designation field 340 (e.g., for designating the zip code in which the property resides), and other like property identifying fields.

Continuing in FIG. 3B, the property information fields 330 can include a property type field 342 for designating the type of property to be inspected. For purposes of illustration and not limitation, the property type field 342 can be comprised of an appropriate pull-down menu or the like that allows the user to select one of a predetermined number of selections, such as, for example, “single family residence,” “condominium,” “townhouse,” “other,” or any other suitable property type designation. The property information fields 330 can include a year built designation field 344 for designating the year in which the property was built.

The property information fields 330 can include a property specification field 346. The property specification field 346 is configured to allow the user to enter specifications of the property or other task parameters that can be used according to exemplary embodiments of the present invention to determine the total time needed to inspect the property. For purposes of illustration and not limitation, the property specification field 346 can allow the user to enter the total square footage of the property to be inspected (e.g., “2500” for the particular example illustrated in FIG. 3B).

The property information fields 330 can include any suitable type of additional fields that can provide additional identifying and characterizing information regarding the property to be inspected, such as, for example, a bedroom quantity designation field 348 (e.g., for designating the number of bedrooms in the property), bathroom quantity designation field 350 (e.g., for designating the number of bathrooms in the property), vacancy designation field 352 (e.g., for designating whether the property is “occupied” or “vacant”), cross street designation field 354 (e.g., for designating the nearest cross street to the property), gated designation field 356 (e.g., for designating whether the property is gated or not), kitchen quantity designation field 358 (e.g., for designating the number of kitchens in the property), and other like property identifying fields.

The first GUI 300 can include any suitable number and types of additional fields for entering property information or indicating services that can be performed on the property. For example, the first GUI 300 can include an additional services fields 370 (e.g., comprised of service name fields 372 and service description fields 372) that are configured to allow the user to specify any services (and corresponding fees) that are to be performed in addition or alternatively to a home inspection (e.g., a moisture intrusion and mold consultation, or the like). Once the appropriate property information is entered into the fields graphically presented in first GUI 300, the user can select a continue button 380 or other navigation button to continue to the next GUI to enter further information.

According to exemplary embodiments, the systems 100 and 200 (e.g., via task time generation module 105 or inspection duration determination module 205, respectively) can use at least the square footage information entered into the property specification field 346, the date by which the user needs an appointment to be completed that was entered into the date window 314, and the schedules corresponding to the name(s) of the service professional(s) that was entered into the inspector designation field 312 to generate a list of inspectors available to inspect the property. Other factors can be used by these respective modules to generate the list of available inspectors, such as, for example, the addresses of the properties. Such property address information can be used by the availability determination module 110 or the roster generation module 215 to calculate the travel times to start of business/close of business addresses and other appointment addresses when determining both the availability of an inspector and for the geo-coded sort order of the list of available inspectors that are displayed.

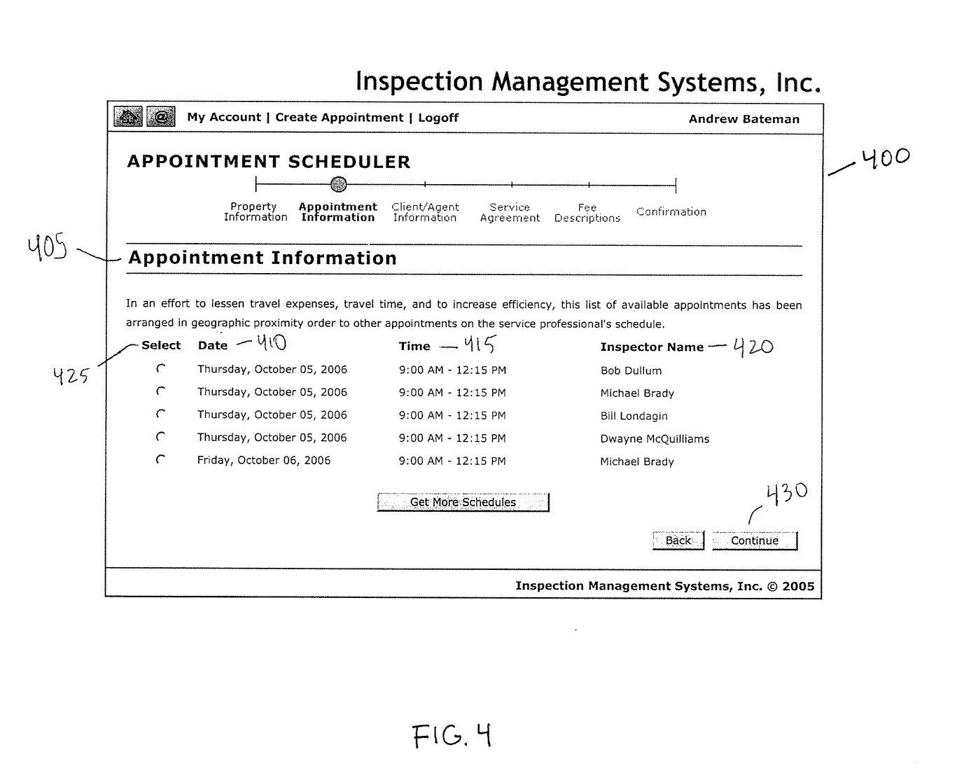

FIG. 4 is a diagram illustrating a second graphical user interface 400 that can be displayed via the display module 235 for automatically scheduling appointments for inspecting a property, in accordance with an exemplary embodiment of the present invention. For purposes of illustration and not limitation, using the “first available inspector” designated in the inspector designation field 312, the date of “Tuesday, October 10, 2006” entered into date window 314, and the total square footage of “2500” entered into the property specification field 346, the system 200 can generate the appointment information 405 of the second GUI 400 illustrated in FIG. 4. The appointment information 405 provides an indication of the date 410 each inspector is available, the total time 415 needed by each inspector to inspect the property, and the name 420 of each inspector available to conduct the inspection.

For purposes of illustration and not limitation, based on the aforementioned information supplied by the user, the system 200 can calculate, in the manner described previously, that it will take approximately three hours and fifteen minutes for one inspector to conduct the inspection of the given property (as the appointments specified in the fields for total time 415 are each from 9:00 am to 12:15 pm). In addition, the system 400 has arranged the list of available appointments in geographic proximity order to other appointments on the service professional's schedule by using, for example, the address information provided in the state designation field 332, county designation field 334, street address designation field 336, city designation field 338, and/or zip code designation field 340 illustrated in FIG. 3A. The user can select one of the appointments listed in the appointment information 405 by appropriately choosing one of the selection buttons 425 and then selecting a continue button 430 or other navigation button to continue to the next GUI to enter additional information as part of the scheduling process according to exemplary embodiments of the present invention.

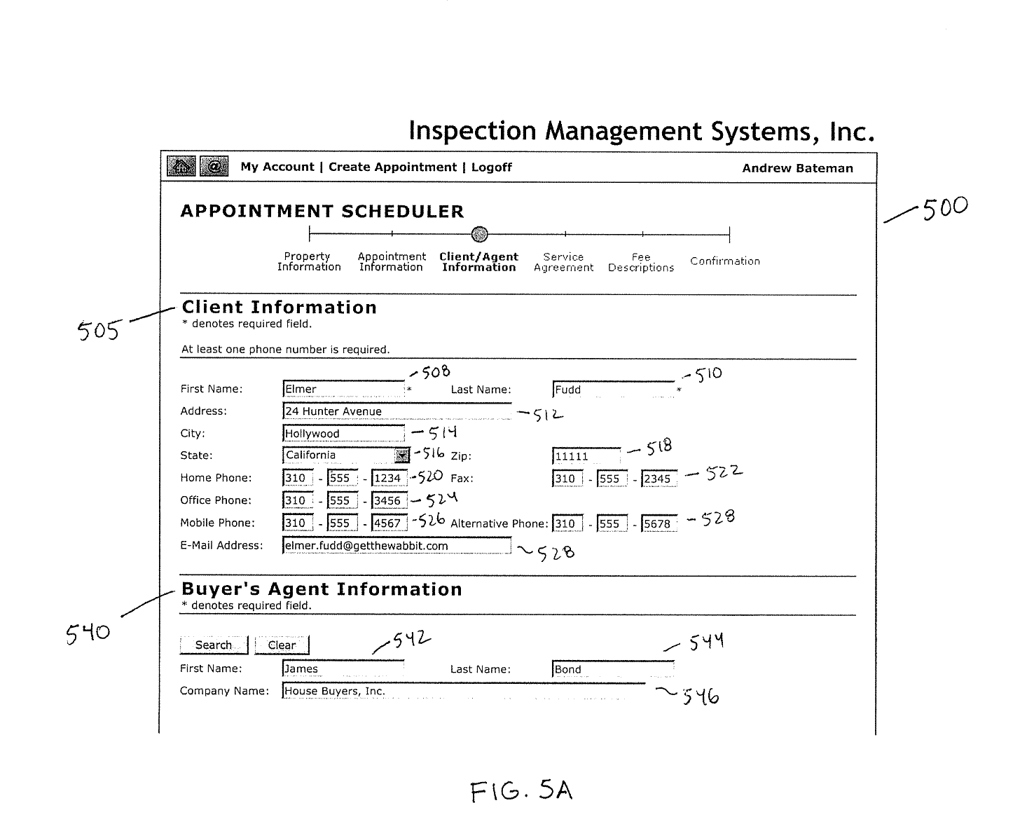

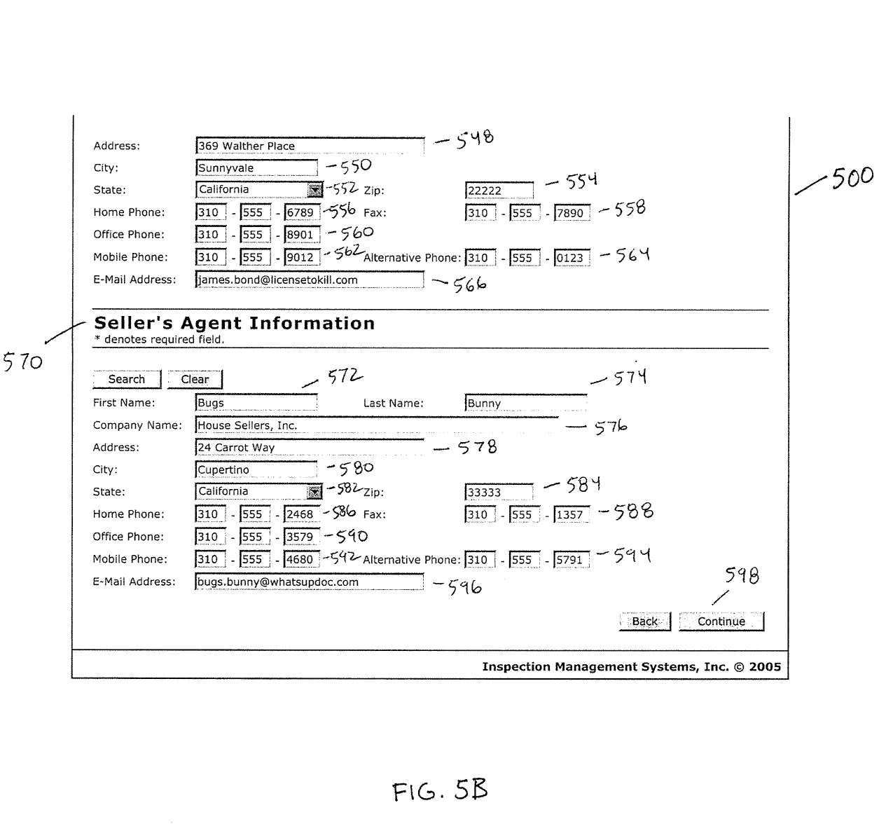

Once the user has chosen a particular appointment, further uniquely identifying information about the user can be supplied to the system 200. FIGS. 5A and 5B are diagrams illustrating a third graphical user interface 500 that can be displayed via the display module 235 for automatically scheduling appointments for inspecting a property, in accordance with an exemplary embodiment of the present invention. The third GUI 500 includes fields for entering suitable client and/or agent information associated with the user. For example, the third GUI 500 can include client information fields 505. The client information fields 505 can include fields for uniquely designating the client (e.g., the user), such as, for example, first name field 508, last name field 510, street address field 512, city field 514, state field 516, zip code field 518, home phone field 520, fax number field 522, office phone field 524, mobile phone field 526, alternative phone field 528, and e-mail address field 528.

The third GUI 500 can include buyer's agent information fields 540. As illustrated in FIGS. 5A and 5B, the buyer's agent information fields 540 can include fields for uniquely designating the buyer's agent, such as, for example, first name field 542, last name field 544, company name field 546, street address field 548, city field 550, state field 552, zip code field 554, home phone field 556, fax number field 558, office phone field 560, mobile phone field 562, alternative phone field 564, and e-mail address field 566.

The third GUI 500 can include seller's agent information fields 570. As illustrated in FIG. 5B, the seller's agent information fields 570 can include fields for uniquely designating the seller's agent, such as, for example, first name field 572, last name field 574, company name field 576, street address field 578, city field 580, state field 582, zip code field 584, home phone field 586, fax number field 588, office phone field 590, mobile phone field 592, alternative phone field 594, and e-mail address field 596. Once the user has entered the appropriate client, buyer's agent, and seller's agent information, the user can select a continue button 598 or other navigation button to continue to any additional GUI.

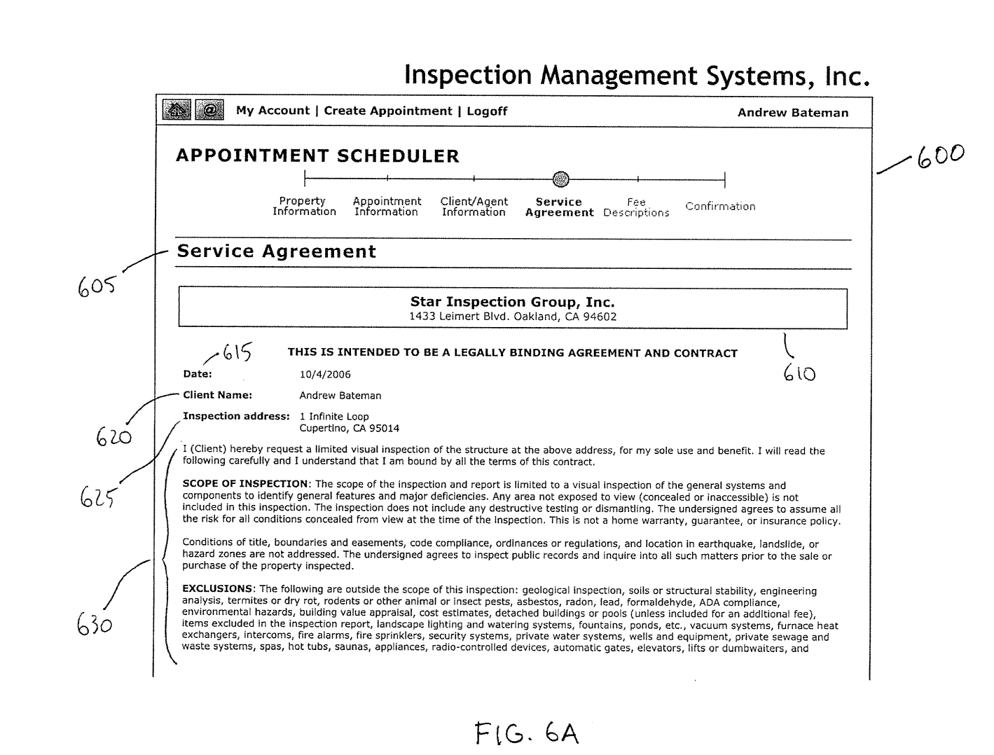

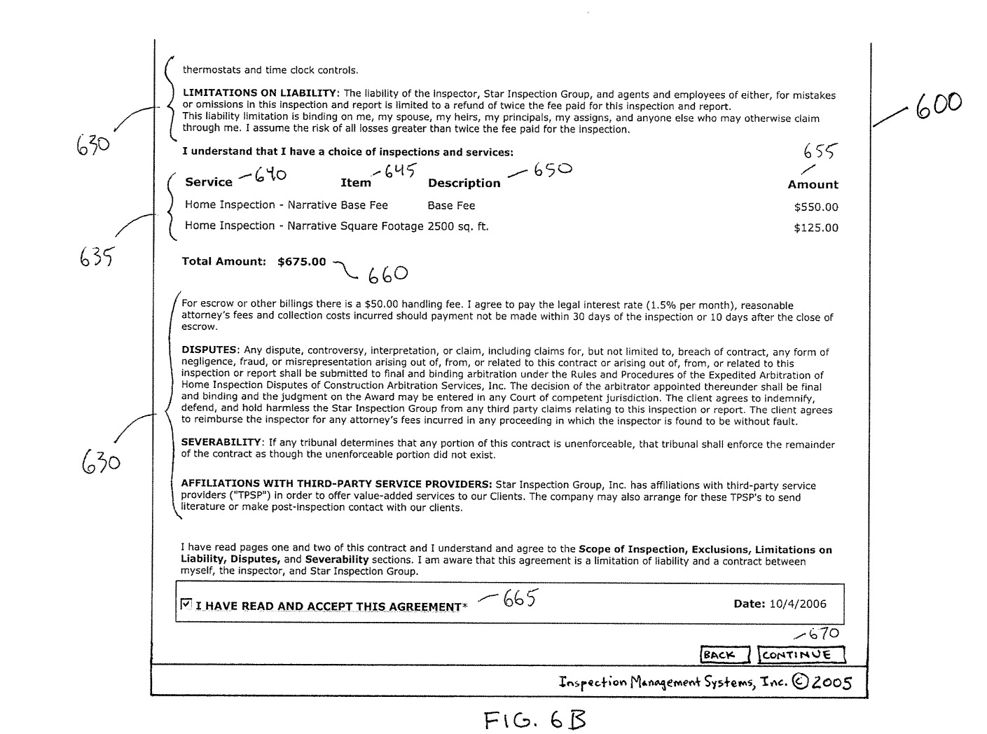

Prior to scheduling the appointment, the system 200 can present any appropriate legal or contractual terms to the user for review and acceptance. FIGS. 6A and 6B are diagrams illustrating a fourth graphical user interface 600 that can be displayed via the display module 235 for automatically scheduling appointments for inspecting a property, in accordance with an exemplary embodiment of the present invention. As illustrated in FIGS. 6A and 6B, the fourth GUI 600 can present a service agreement 605 or other contractual terms to the user. For example, the service agreement 605 can present the name 610 of the designated inspection company, the date 615 of the service agreement 605, the client name 620, the inspection address 625, and the terms 630 of the service agreement 605. As illustrated in FIG. 6B, the service agreement 605 can also display a list of the user's choices of inspection and services, including such fields as, for example, service field 640, item field 645, description field 650, amount field 655 for each service, and total amount field 660 for all services. Before the system 200 makes the appointment, the service agreement 605 can include an acceptance indication field 665 that can comprise a checkbox or other button that is selectable by the user to indicate acceptance of the terms of the service agreement 605 by the user. If the acceptance indication field 665 is selected by the user (indicating positive acceptance of the terms of the service agreement 605 by the user), the user can select a continue button 670 or other navigation button to cause the system 200 to schedule the appointment and continue to any additional GUI.

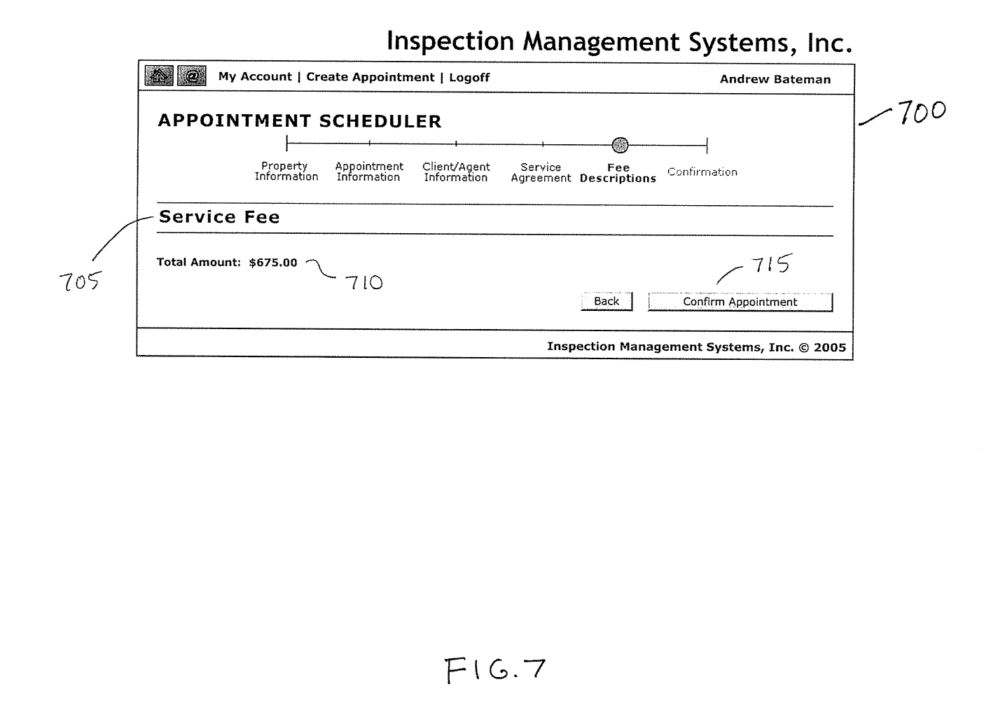

To confirm the scheduling of the appointment, the system 200 can provide any suitable type of appointment confirmation message to the user. FIG. 7 is a diagram illustrating a fifth graphical user interface 700 that can be displayed via the display module 235 for automatically scheduling appointments for inspecting a property, in accordance with an exemplary embodiment of the present invention. The fifth GUI 700 can include, for example, a total service fee indication 705 that can display the total amount 710 of the inspection services fees (e.g., “$675.00”) that is calculated by the system 200 in accordance with, for example, the determined total time for performing the inspection, the types of inspection services desired, the hourly rate of the chosen inspector, and other like factors, as discussed previously (e.g., by fee determination module 120 of system 100 or inspection fee determination module 210). To confirm the appointment, the user can select a confirm appointment button 715 or other suitable button to accept the appointment, the fees for the service, and the like. Once the appointment has been confirmed upon selection of the confirm appointment button 715, a suitable confirmation message can be graphically displayed to the user (e.g., in a pop-up window or separate GUI page), sent to the user (e.g., to the user's e-mail address via e-mail or other electronic delivery or fax), or the like so that the user can be provided with a positive indication and a reminder that the appointment has been successfully scheduled.

Those of ordinary skill in the art will recognize that each of the modules of the systems 100 and 200 can be located locally to or remotely from each other, while use of the systems 100 and 200 as a whole still occurs within a given country, such as the United States. For example, merely for purposes of illustration and not limitation, task time generation module 105, availability determination module 110 (including geographical proximity scheduling module 112), appointment module 115, fee determination module 120, storage module 125, communication module 135, artifact delivery module 145, workflow management module 150 (or any combination of such modules) can be located extraterritorially to the United States (e.g., in Canada and/or in one or more other foreign countries), while the display module 130 can be located within the United States, such that the control of the system 100 as a whole is exercised and beneficial use of the system 100 is obtained by the user within the United States.

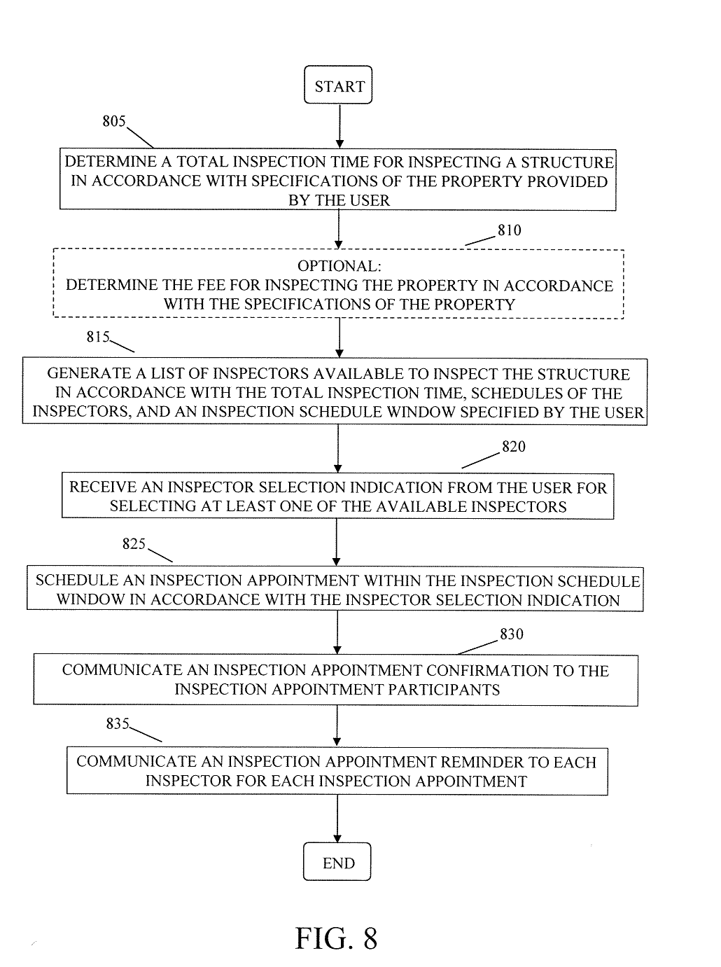

FIG. 8 is a flowchart illustrating steps for automatically scheduling an appointment for inspecting a property, in accordance with an exemplary embodiment of the present invention. In step 805, a total inspection time for inspecting the property is determined in accordance with specifications of the property provided by a user. According to an exemplary embodiment, the specifications of the property can include, for example, the total square footage of the property or other suitably descriptive information associated with the property. Optionally, in step 810, the fee for inspecting the property can be determined in accordance with the specifications of the property provided by the user. In step 815, a list of inspectors available to inspect the property is generated in accordance with the total inspection time, schedules of the inspectors, and an inspection schedule window specified by the user. Other factors can be used to generate the list of available inspectors, including, but not limited to, the travel times calculated before and/or after appointments or other predetermined locations, and other like factors. In step 820, an inspector selection indication is received from the user for selecting at least one of the available inspectors. In step 825, an inspection appointment is scheduled within the inspection schedule window in accordance with the inspector selection indication. The schedule of available inspection appointments and other like information can be displayed to the user and/or stored for later retrieval.

According to exemplary embodiments, the list generation performed in step 815 can include one or more of the steps of, for example: sorting the list of available inspectors in geographic order in accordance with travel times to and from the property; determining travel time to and from the property in accordance with an address of the property; scheduling the inspection appointment to include the travel time; receiving a travel offset for modifying the travel time to and from the property; modifying the time length of the travel time in accordance with the travel offset; generating a list of inspection appointments ranked in order of geographical proximity to a predetermined location; and/or optimizing the travel schedule for each inspector in accordance with geographical locations of inspection appointments for each day. As discussed previously, a plurality of inspectors can be assigned for the inspection appointment. For example, a portion of the inspection appointment can be allotted to each of the plurality of inspectors.

In step 830, an inspection appointment confirmation can be communicated to the inspection appointment participants. According to exemplary embodiments, the text of the inspection appointment confirmation can be customizable (e.g., by the company or organization with which the inspector is employed or otherwise affiliated). In step 835, an inspection appointment reminder can be communicated to each inspector (and/or the users) for each inspection appointment. However, an inspection appointment reminder can be communicated to any or all of the inspection appointment participants. The inspection appointment reminder can include, for example, a log or other daily schedule of substantially all inspection appointments for a day for the inspector. The inspection appointment reminder can also include travel directions for inspection appointments. Additionally or alternatively, the inspection appointment reminder can include a message customized for each inspector or other inspection appointment participant. Artifacts resulting from an inspector performing an inspection and completing the appointment can also be communicated, for example, to the user. The process illustrated in FIG. 8 can be repeated any appropriate number of times to schedule any suitable number of appointments for each and any user.

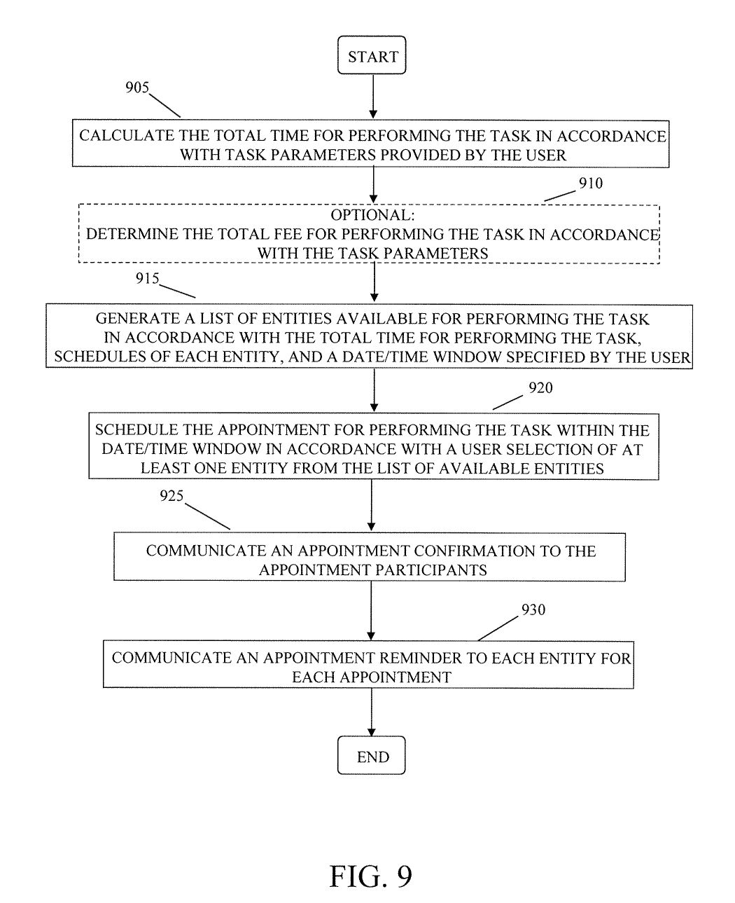

FIG. 9 is a flowchart illustrating steps for automatically scheduling an appointment for performing a task, in accordance with an exemplary embodiment of the present invention. In step 905, the total time for performing the task is calculated in accordance with task parameters provided by a user. Optionally, in step 910, the total fee for performing the task can be determined in accordance with the task parameters provided by the user. In step 915, a list of entities available for performing the task is generated in accordance with the total time for performing the task, schedules of each entity, and a date/time window specified by the user. Other factors can be used to generate the list of available entities, including, but not limited to, the travel times calculated before and/or after appointments or other predetermined locations, whether or not entities are configured to perform the task, and other like factors. In step 920, the appointment for performing the task is scheduled within the date/time window in accordance with a user selection of at least one entity from the list of available entities. The schedule of available appointments and other like information can be displayed to the user and/or stored for later retrieval.

According to exemplary embodiments, the list generation performed in step 915 can include one or more of the steps of, for example: sorting the list of available entities in geographic order in accordance with travel times to and from a task site; determining travel time to and from a task site in accordance with an address of the task site; scheduling the appointment to include the travel time; receiving a travel offset for modifying the travel time to and from the task site; modifying a time length of the travel time in accordance with the travel offset; generating a list of appointments ranked in order of geographic proximity to a predetermined location; optimizing a travel schedule for each entity in accordance with geographical locations of appointments for each day; assigning a plurality of entities for the appointment; and/or allotting a portion of the appointment to each of the plurality of entities.

In step 925, an appointment confirmation can be communicated to any or all of the appointment participants. According to exemplary embodiments, the text of the appointment confirmation can be customizable (e.g., by the entity or the company or organization with which the entity is employed or otherwise affiliated). In step 930, an appointment reminder can be communicated to each entity (and/or the users) for each appointment. However, an appointment reminder can be communicated to any or all of the appointment participants. The appointment reminder can include, for example, a log or other daily schedule of substantially all appointments for a day for the entity. The appointment reminder can also include travel directions for appointments. Additionally or alternatively, the appointment reminder can include a message customized for each entity or any other appointment participant. Artifacts resulting from the entity performing the task or otherwise completing the appointment can be communicated, for example, to the user. The process illustrated in FIG. 9 can be repeated any appropriate number of times to schedule any suitable number of appointments for each and any user.

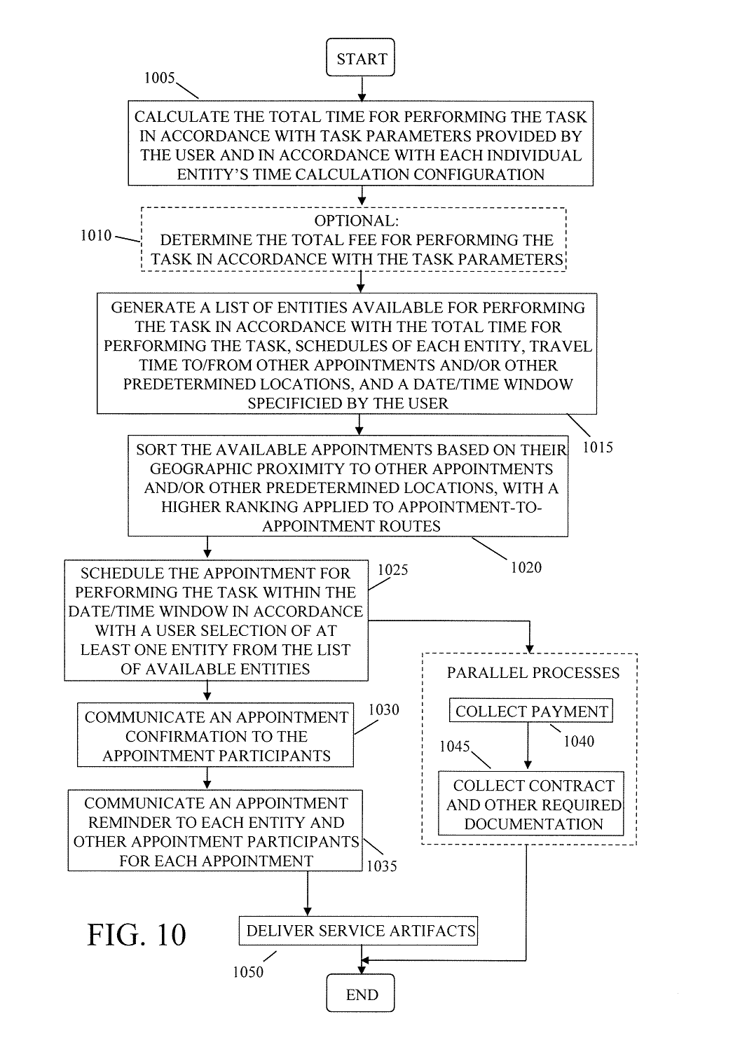

FIG. 10 is a flowchart illustrating steps for automatically scheduling an appointment for performing a task, in accordance with an alternative exemplary embodiment of the present invention. In step 1005, the total time for performing the task is calculated in accordance with task parameters provided by the user, and in accordance with each individual entity's time calculation configuration. Optionally, in step 1010, the total fee for performing the task can be determined in accordance with the task parameters provided by the user. In step 1015, a list of entities available for performing the task is generated in accordance with the total time for performing the task, schedules of each entity, travel times to/from other appointments and/or other predetermined locations, and a date/time window specified by the user. In step 1020, the available appointments are sorted based on their geographic proximity to other appointments and/or other predetermined locations, with a higher ranking applied to appointment-to-appointment routes. In step 1025, the appointment for performing the task is scheduled in the date/time window in accordance with a user selection of at least one entity from the list of available entities. In step 1030, an appointment confirmation is communicated is communicated to the appointment participants. In step 1035, appointment reminders are communicated to each entity and other appointment participants for each appointment. Concurrently with at least steps 1025, 1030, and 1035, the processes of steps 1040 and 1045 can be performed in parallel. In step 1040, payment for the task can be collected from the user. In step 1045, contract and other required documentation can be collected from the user. In step 1050, the service artifacts are delivered to, for example, the user (e.g., upon successful collection of payment and documentation).

Each, all or any combination of the steps of a computer program as illustrated in FIGS. 8, 9, and 10 for automatically scheduling an appointment for performing a task can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. As used herein, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Exemplary embodiments of the present invention can be used in conjunction with any device, system or process for automatically scheduling appointments for performing one or more tasks. Exemplary embodiments can provide users of the present invention with cost-savings and increased operational efficiencies by effectively scheduling appointments. For example, exemplary embodiments of the present invention can be used in the field of home inspections to maximize the scheduling efficiency of each inspector so that each inspector can perform the greatest number of inspections in any given day, thereby increasing the influx of fees received for performing such services. However, the present invention can be used for automatically scheduling appointments for any suitable type of task, service, job, assignment, chore, duty, endeavor, enterprise, project, undertaking, function, mission, errand or other work for which one or more individuals, equipment, or the like can be scheduled.

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

All United States patents and applications, foreign patents and applications, and publications discussed above are hereby incorporated by reference herein in their entireties.

What is claimed is:

1. A system for automatically scheduling an appointment for inspecting a property, comprising:
an inspection duration determination module,
wherein the inspection duration determination module is configured to determine a total inspection time for inspecting the property in accordance with specifications of the property provided by a user;
a roster generation module in communication with the inspection duration determination module,
wherein the roster generation module is configured to generate a list of inspectors available to inspect the property in accordance with the total inspection time, schedules of the inspectors, and an inspection schedule window specified by the user, and
wherein the roster generation module is configured to receive an inspector selection indication from the user for selecting at least one of the available inspectors; and
a scheduler module in communication with the roster generation module,
wherein the scheduler module is configured to schedule an inspection appointment within the inspection schedule window in accordance with the inspector selection indication.

2. The system of claim 1, wherein the inspection duration determination module is configured to determine a total fee for the inspection appointment in accordance with the specifications of the property provided by the user.

3. The system of claim 1, comprising:
a geographical proximity scheduling module in communication with the roster generation module,
wherein the geographical proximity scheduling module is configured to sort the list of available inspectors in geographic order in accordance with travel times to and from the property.

4. The system of claim 1, comprising:
an artifact delivery module in communication with the scheduler module,
wherein the artifact delivery module is configured to communicate artifacts resulting from an inspector performing an inspection.

5. The system of claim 1, comprising:
a workflow management module in communication with the scheduler module,
wherein the workflow management module is configured to manage task workflows for an inspection appointment.

6. A method of automatically scheduling an appointment for inspecting a property, comprising the steps of:
a.) determining a total inspection time for inspecting the property in accordance with specifications of the property provided by a user;
b.) generating a list of inspectors available to inspect the property in accordance with the total inspection time, schedules of the inspectors, and an inspection schedule window specified by the user;
c.) receiving an inspector selection indication from the user for selecting at least one of the available inspectors; and
d.) scheduling an inspection appointment within the inspection schedule window in accordance with the inspector selection indication.

7. The method of claim 6, comprising the step of:
e.) determining a total fee for the inspection appointment in accordance with the specifications of the property provided by the user.

8. The method of claim 6, comprising the step of:
e.) sorting the list of available inspectors in geographic order in accordance with travel times to and from the property.

9. The method of claim 6, comprising the step of:
e.) communicating artifacts resulting from an inspector performing an inspection.

10. A system for automatically scheduling an appointment for performing a task, comprising:
a task time generation module,
wherein the task time generation module is configured to calculate a total time for performing the task in accordance with task parameters provided by a user;
an availability determination module in communication with the task time generation module,
wherein the availability determination module is configured to generate a list of entities available for performing the task in accordance with the total time for performing the task, schedules of each entity, and a date/time window specified by the user; and
an appointment module in communication with the availability determination module,
wherein the appointment module is configured to schedule the appointment for performing the task within the date/time window in accordance with a user selection of at least one entity from the list of available entities.

11. The system of claim 10, comprising:
a fee determination module,
wherein the fee determination module is configured to determine a total fee for the appointment in accordance with the task parameters provided by the user.

12. The system of claim 10, wherein the availability determination module comprises:
a geographical proximity scheduling module,
wherein the geographical proximity scheduling module is configured to sort the list of available entities in geographic order in accordance with travel times to and from the task site.

13. The system of claim 10, comprising:
an artifact delivery module in communication with the appointment module,
wherein the artifact delivery module is configured to communicate artifacts resulting from an entity performing the task.

14. The system of claim 10, comprising:
a workflow management module in communication with the appointment module,
wherein the workflow management module is configured to manage task workflows for an appointment.

15. The system of claim 10, comprising:
a display module in communication with the appointment module.

16. The system of claim 15, wherein the display module is configured to display a schedule of available appointments.

17. The system of claim 10, comprising:
a communication module in communication with the appointment module.

18. The system of claim 10, wherein the appointment module is configured to communicate an appointment confirmation to appointment participants via the communication module.

19. The system of claim 10, wherein the appointment module is configured to communicate an appointment reminder to each entity for each appointment via the communication module.

20. The system of claim 19, wherein the appointment reminder includes a log of substantially all appointments for a day for the entity.

21. The system of claim 19, wherein the appointment reminder includes travel directions for appointments.

22. The system of claim 10, wherein the availability determination module is configured to determine travel time to and from a task site in accordance with an address of a task site, and
wherein the availability determination module is configured to include the travel time in generating the list of available entities.

23. The system of claim 22, wherein the availability determination module is configured to receive a travel offset for modifying the travel time to and from the task site, and
wherein the availability determination module is configured to modify a time length of the travel time in accordance with the travel offset.

24. The system of claim 10, wherein the availability determination module is configured to generate a list of appointments ranked in order of geographic proximity to a predetermined location.

25. The system of claim 10, wherein the availability determination module is configured to optimize a travel schedule for each entity in accordance with geographical locations of appointments for each day.

26. The system of claim 10, wherein the availability determination module is configured to assign a plurality of entities for the appointment.

27. The system of claim 26, wherein the availability determination module is configured to allot a portion of the appointment to each of the plurality of entities.

28. A method of automatically scheduling an appointment for performing a task, comprising the steps of:
a.) calculating a total time for performing the task in accordance with task parameters provided by a user;
b.) generating a list of entities available for performing the task in accordance with the total time for performing the task, schedules of each entity, and a date/time window specified by the user; and
c.) scheduling the appointment for performing the task within the date/time window in accordance with a user selection of at least one entity from the list of available entities.

29. The method of claim 28, comprising the step of:
d.) determining a total fee for the appointment in accordance with the task parameters provided by the user.

30. The method of claim 28, comprising the step of:
d.) sorting the list of available entities in geographic order in accordance with travel times to and from a task site.

31. The method of claim 28, comprising the step of:
d.) communicating artifacts resulting from an entity performing the task.

32. The method of claim 28, comprising the step of:
d.) determining travel time to and from a task site in accordance with an address of a task site; and
e.) scheduling the appointment to include the travel time.

33. The method of claim 32, comprising the steps of:
f.) receiving a travel offset for modifying the travel time to and from the task site; and
g.) modifying a time length of the travel time in accordance with the travel offset.

34. The method of claim 28, comprising the step of:
d.) generating a list of appointments ranked in order of geographic proximity to a predetermined location.

35. The method of claim 28, comprising the step of:
d.) optimizing a travel schedule for each entity in accordance with geographical locations of appointments for each day.
